(19) United States
(12) Patent Application Publication
(10) Pub. No.: US 2026/0238338 A1
(43) Pub. Date: Aug. 13, 2026

(54) DEVICE POSITIONING IN NON-TERRESTRIAL NETWORKS

(71) Applicant: Lenovo (Singapore) Pte. Limited, Singapore (SG)

(72) Inventors: Robin Rajan Thomas, Bad Nauheim (DE); Sher Ali Cheema, llmenau (DE); Vijay Nangia, Woodridge, IL (US)

(73) Assignee: Lenovo (Singapore) Pte. Limited, Singapore (SG)

(21) Appl. No.: 19/156,215

(22) PCT Filed: Feb. 15, 2024
(86) PCT No.: PCT/IB2024/051450

§ 371 Date: Aug. 13, 2025

Related U.S. Application Data
(60) Provisional application No. 63/485,088, filed on Feb. 15, 2023.

(51) Int. Cl. H04B 7/185

(52) U.S. Cl. CPC H04B 7/18547; H04B 7/18513

(57) ABSTRACT

Various aspects of the present disclosure relate to methods, apparatuses, and systems that support device positioning in NTN. For instance, implementations provide for determination and reporting of device (e.g., UE) location in NTN implementations. The implementations described in this disclosure, for example, enable adaption of different types of positioning time-based measurements such that the location and/or positioning performance is not degraded for NTN scenarios including single-satellite cases. Further, adapted measurements can include gNB Rx-Tx time difference, DL RSTD, UL RTOA measurements, etc. Implementations also provide techniques to configure the measurement and reporting of positioning time-based measurements for single-satellite scenarios such that consecutive measurements may be reported with a minimum time gap for an NTN scenario and a dedicated NTN measurement gap may be configured for positioning measurements performed outside an active DL BWP.

### RELATED APPLICATION

This application claims priority to U.S. Provisional Application Ser. No. 63/485,088 filed 15 Feb. 2023 entitled “DEVICE POSITIONING IN NON-TERRESTRIAL NETWORKS,” the disclosure of which is incorporated by reference herein in its entirety.

### TECHNICAL FIELD

The present disclosure relates to wireless communications, and more specifically to position determination in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for attempting to determine a position of devices, e.g., UEs. Current position determination techniques, however, may have difficulty in determining device position in the context of non-terrestrial networks (NTN).

### SUMMARY

The present disclosure relates to methods, apparatuses, and systems that support device positioning in NTN. For instance, implementations provide for determination and reporting of device (e.g., UE) location in NTN implementations. The implementations described in this disclosure, for example, enable adaption of different types of positioning time-based measurements such that location and/or positioning performance is not degraded for NTN scenarios including single-satellite cases. Further, adapted measurements can include gNB Rx-Tx time difference, downlink (DL) RSTD, uplink (UL) relative time of arrival (RTOA) measurements, etc. Implementations also provide techniques to configure the measurement and reporting of positioning time-based measurements for single-satellite scenarios such that consecutive measurements may be reported with a minimum time gap for an NTN scenario and a dedicated NTN measurement gap may be configured for positioning measurements performed outside an active DL bandwidth part (BWP).

By utilizing the described techniques, accurate and timely determination of device (e.g., UE) position in NTN scenarios can be realized.

Some implementations of the methods and apparatuses described herein may further include receiving, at a first network entity and from a second network entity, one or more positioning measurement configurations to perform time-based positioning; receiving, at the first network entity, one or more uplink positioning reference signals from a target device; performing one or more time-based positioning measurements based at least in part on the one or more uplink positioning reference signals and the one or more positioning measurement configurations; and transmitting, based at least in part on the one or more time-based positioning measurements, one or more positioning measurement reports to the second network entity.

Some implementations of the methods and apparatuses described herein may further include: where the one or more positioning measurement configurations include at least one of satellite link delay information, satellite ephemeris information, or satellite displacement information; the first network entity includes a non-terrestrial network (NTN) next generation radio access network (NG-RAN) node, and the second network entity includes a location server; the NG-RAN node includes one or more of a satellite, a gateway, or a gNB; performing the one or more time-based positioning measurements includes performing a plurality of non-terrestrial network (NTN) gNB receiver-transmitter time difference measurements based at least in part on a feeder link delay and a total delay; the one or more NTN gNB receiver-transmitter time difference measurements include a difference between a reception time of the one or more uplink positioning reference signals and a transmission time of one or more downlink positioning reference signals.

Some implementations of the methods and apparatuses described herein may further include: where the total delay includes the feeder link delay and a service link delay; the one or more uplink positioning reference signals include one or more of sounding reference signals (SRS) for positioning or multiple input multiple output (MIMO) SRS; performing a relative time-of-arrival (TOA) measurement based on a plurality of satellite displacement times and according to the received one or more uplink positioning reference signals; receiving, from the second network entity, a non-terrestrial network (NTN) reporting criteria including a set of configurable time instances in which to provide positioning measurement reports; the set of configurable time instances include a number of time instances and absolute reporting times.

Some implementations of the methods and apparatuses described herein may further include receiving, at an apparatus and from a first network entity, one or more positioning measurement configurations to perform time-based positioning; receiving, at the apparatus and from a second network entity, downlink positioning reference signals at different time instances; performing one or more time-based positioning measurements based at least in part on the downlink positioning reference signals and the one or more positioning measurement configurations; and transmitting, based at least in part on the one or more time-based positioning measurements, one or more positioning measurement reports to the second network entity.

Some implementations of the methods and apparatuses described herein may further include where the apparatus includes a user equipment (UE), the first network entity includes a location server, and the second network entity includes a non-terrestrial network (NTN) next generation radio access network (NG-RAN) node; the one or more positioning measurement configurations include at least one of satellite link delay information, satellite ephemeris information, or satellite displacement information; performing the one or more time-based positioning measurements includes performing non-terrestrial network (NTN) reference signal time difference (RSTD) measurements based at least in part on an observed time difference and a real time difference of satellite displacement times; performing the NTN RSTD measurements based at least in part on one or more of RSTD measurement uncertainty or RSTD measurement error.

Some implementations of the methods and apparatuses described herein may further include performing the NTN RSTD measurements based at least in part on a relative timing difference between transmission point (TP) at a satellite displacement time t+NT and a reference satellite displacement time t between a pair of transmission slots; receiving, from the first network entity, a non-terrestrial network (NTN) reporting criteria including a set of configurable time instances in which to provide positioning measurement reports; the set of configurable time instances include a number of time instances and absolute reporting times; receiving, from the first network entity, a non-terrestrial network (NTN) extended measurement gap configuration for performing NTN downlink positioning measurements; the NTN extended measurement gap includes at least one of a gap pattern identifier, a measurement gap length (MGL), or a measurement gap repetition period (MGRP).

### BRIEF DESCRIPTION OF THE DRAWINGS

FIG. 1 illustrates an example of a wireless communications system that supports device positioning in NTN in accordance with aspects of the present disclosure.

FIG. 2 illustrates a system in which positioning reference signals can be utilized to obtain positioning measurements.

FIG. 3 illustrates an example information element that represents an example of DL-TDOA assistance data.

FIGS. 4 and 5 illustrate different portions of an example information element that can be used for a DL-TDOA measurement report.

FIG. 6 illustrates an example architecture applicable to an NG-RAN for UE positioning.

FIG. 7 illustrates an example sequence of signaling events.

FIG. 8 illustrates an example procedure for NG-RAN location reporting.

FIG. 9 illustrates a transparent satellite-based NG-RAN architecture.

FIG. 10 illustrates a regenerative satellite-based NG-RAN architecture.

FIG. 11 illustrates an example of a regenerative satellite-based NG-RAN architecture, such as a regenerative satellite system with an inter-satellite link (ISL).

FIG. 12 illustrates a system that supports device positioning in NTN in accordance with aspects of the present disclosure.

FIG. 13 illustrates a system that supports device positioning in NTN in accordance with aspects of the present disclosure.

FIG. 14 illustrates a system that supports device positioning in NTN in accordance with aspects of the present disclosure.

FIG. 15 illustrates a scenario that supports device positioning in NTN in accordance with aspects of the present disclosure.

FIG. 16 illustrates a system that supports device positioning in NTN in accordance with aspects of the present disclosure.

FIGS. 17 and 18 illustrate portions of an information element (IE) that supports device positioning in NTN in accordance with aspects of the present disclosure.

FIG. 19 illustrates an example of a block diagram of a device (e.g., an apparatus) that supports device positioning in NTN in accordance with aspects of the present disclosure.

FIG. 20 illustrates an example of a block diagram of a device (e.g., an apparatus) that supports device positioning in NTN in accordance with aspects of the present disclosure.

FIG. 21 illustrates a flowchart of a method that supports device positioning in NTN in accordance with aspects of the present disclosure.

FIG. 22 illustrates a flowchart of a method that supports device positioning in NTN in accordance with aspects of the present disclosure.

### DETAILED DESCRIPTION

In wireless communications systems, current position determination techniques may fail to enable verification of a UE's reported location in an NTN deployment. For instance, current positioning determination techniques can be designed for terrestrial networks (TN) such as where a network node (e.g., gNB) is static and at least three measurements for signals transmitted (e.g., PRS) from three network entities (e.g., gNBs) can be used for computation of location estimates, such as in scenarios for DL-TDoA. In contrast to TN scenarios, in NTN a network entity can be moving in scenarios involving regenerative payload (e.g., gNB on board to a satellite) and/or an intermediate moving node (e.g., a satellite) can be used in scenarios involving transparent payload with NG-RAN node, e.g., a gNB on the ground. Thus, due to large coverage areas exhibited by NTN cells, current TN positioning techniques may be insufficient and/or inaccurate. Current positioning techniques may accordingly face challenges when attempting to provide accurate, reliable, and low latency verification of UE location in NTN scenarios, such as considering factors including satellite movement, wider satellite range, higher Doppler shift, etc.

Accordingly, this disclosure provides for techniques that support device positioning in NTN. For instance, implementations provide positioning measurement enhancements for DL and UL RAT-dependent measurements including gNB Rx-Tx time difference, DL RSTD and UL RTOA. Further, gNB Rx-Tx time difference measurements are enhanced by taking into account service link delays, while the DL RSTD and UL RTOA are enhanced via new mechanisms that utilize satellite displacement in order to perform virtual measurements using a single anchor node, e.g., a single satellite. Techniques are also provided for enhancing measurement reporting, such as by specifying criteria including minimum time gaps between measurements. In addition, measurement gap configuration is also adapted to account for transmission delays associated with NTN deployments.

In implementations, the techniques enable adaption of different types of positioning time-based measurements such that location performance is not degraded for NTN scenarios including single-satellite cases. Adapted measurements, for instance, include gNB Rx-Tx time difference, DL RSTD and UL RTOA measurements, which can be enhanced based on factors such as service and feeder link delays and satellite ephemeris data. In implementations, configuration of the measurement and reporting of positioning time-based measurements is provided for the single-satellite case such that consecutive measurements may be reported with a minimum time gap for an NTN scenario and a dedicated NTN measurement gap may be configured for positioning measurements performed outside an active DL BWP.

Thus, by utilizing the described techniques, accurate and timely determination of device (e.g., UE) position in NTN scenarios can be realized.

Aspects of the present disclosure are described in the context of a wireless communications system. Aspects of the present disclosure are further illustrated and described with reference to device diagrams and flowcharts.

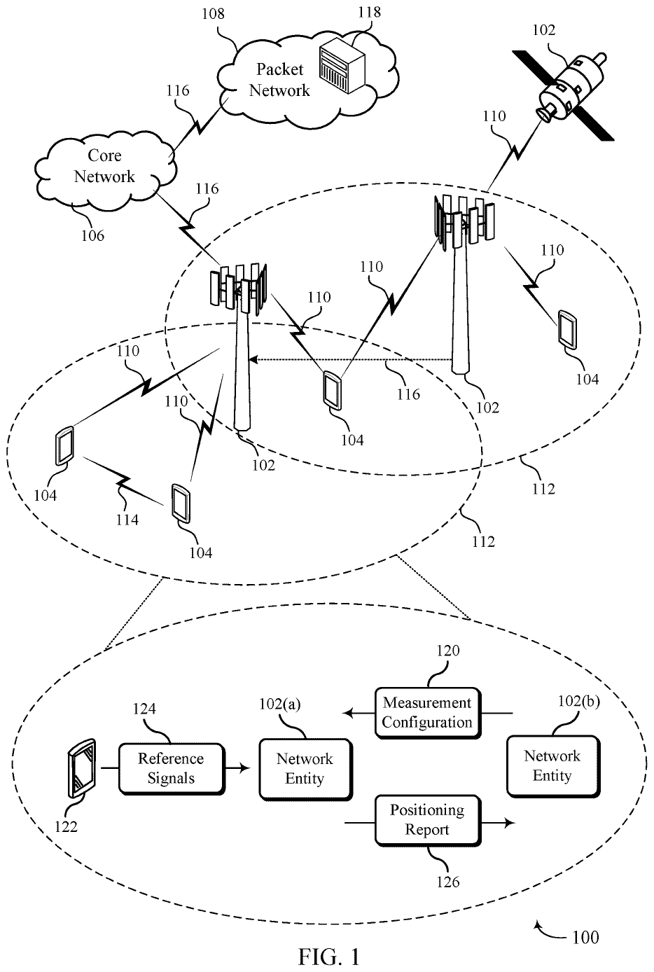

FIG. 1 illustrates an example of a wireless communications system 100 that supports device positioning in NTN in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a location management function (LMF), which is a control plane entity that manages location-related services, a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for device positioning in NTN, a network entity 102(a) receives from a network entity 102(b) a measurement configuration 120 to perform time-based positioning of a target device 122, e.g., a target UE 104. In at least one implementation the network entity 102(a) represents an NTN NG-RAN node and the network entity 102(b) represents a location server. The network entity 102(a) receives reference signals 124 (e.g., uplink positioning reference signals) from the target device 122, performs time-based positioning measurements based at least in part on the reference signals 124 and the measurement configuration 120, and generates a positioning report 126 based at least in part on the time-based positioning measurements. The network entity 102(a) can transmit the positioning report 126 to the network entity 102(b) and the network entity 102(b) can utilize information from the positioning report 126 to estimate a location of the target device 122.

In some wireless communications systems, NR positioning based on NR Uu signals and standalone (SA) architecture (e.g. beam-based transmissions) are specified. The target use cases include commercial and regulatory (emergency services) scenarios. The performance parameters include the following [Technical Report (TR) 38.855]:

| Positioning Error | Indoor | Outdoor |
|---|---|---|
| Horizontal Positioning | <3 m for 80% | <10 m for 80% |
| | of UEs | of UEs |
| Vertical Positioning | <3 m for 80% | <3 m for 80% |
| | of UEs | of UEs |

Further, some systems specify positioning performance parameters for commercial and IIoT use cases as follows [TR 38.857]:

| Positioning Error | Commercial | IIoT |
|---|---|---|
| Horizontal Positioning | (<1 m) for 90% | (<0.2 m) for 90% |
| | of UEs | of UEs; |
| Vertical Positioning | (<3 m) for 90% | (<1 m) for 90% |
| | of UEs | of UEs |
| Physical layer latency | (<10 ms) | (<10 ms) |
| for position estimation | | |
| of UE | | |
| End-to-End Latency | (<100 ms) | (<100 ms, in the order |
| for position estimation | | of 10 ms is desired) |
| of UE | | |

At least some supported positioning techniques are as follows in Table 1 [TS38.305]:

TABLE 1
Supported UE positioning methods

| | | UE- | NG- | |
|---|---|---|---|---|
| | | assisted, | RAN | |
| | UE- | LMF- | node | |
| Method | based | based | assisted | SUPL |
| A-GNSS | Yes | Yes | No | Yes (UE- |
| | | | | based and |
| | | | | UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE 1}
This includes Terrestrial Beacon System (TBS) positioning based on PRS signals.
^{NOTE 2}
In this version of the specification only OTDOA based on LTE signals is supported.
NOTE 3:
Void.
^{NOTE 4}
This includes Cell-Identifier (Cell-ID) for NR method.
^{NOTE 5}
In this version of the specification only for TBS positioning based on Metropolitan Beacon System (MBS) signals.
NOTE 6:
Void

Separate positioning techniques as indicated in Table 1 can be currently configured and performed based on the requirements of the LMF and UE capabilities. The transmission of positioning reference signals (PRS) enable the UE to perform UE positioning-related measurements to enable the computation of a UE's location estimate and are configured per Transmission Reception Point (TRP), where a TRP may transmit one or more beams.

The following RAT-dependent positioning techniques can be supported [TS38.305]:

Downlink time difference of arrival (DL-TDOA) positioning methods make use of the DL RSTD (and optionally DL PRS Reference Signal Received Power (RSRP)) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

DL AoD positioning methods make use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Multi-Round Trip Time (RTT) positioning methods make use of the UE Rx-Tx measurements and DL PRS RSRP of downlink signals received from multiple TRPs, measured by the UE and the measured gNB Rx-Tx measurements and Uplink (UL) SRS-RSRP at multiple TRPs of uplink signals transmitted from UE. The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server which are used to estimate the location of the UE.

In an Enhanced Cell Identifier (E-CID) positioning method, the position of a UE is estimated with the knowledge of its serving ng-eNB, gNB and cell and is based on LTE signals. The information about the serving ng-eNB, gNB and cell may be obtained by paging, registration, or other methods. NR E-CID positioning refers to techniques which use additional UE measurements and/or NR radio resource and other measurements to improve the UE location estimate using NR signals. Although NR E-CID positioning may utilize some of the same measurements as the measurement control system in the RRC protocol, the UE generally is not expected to make additional measurements for the sole purpose of positioning; e.g., the positioning procedures do not supply a measurement configuration or measurement control message, and the UE reports the measurements that it has available rather than being required to take additional measurement actions.

UL TDOA positioning methods make use of the UL TDOA (and optionally UL SRS-RSRP) at multiple receive points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

UL AoA positioning methods make use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

### RAT-Independent Positioning Techniques can Also be Implemented, Including [TS38.305]:

Network-assisted Global Navigation Satellite System (GNSS) methods: These methods make use of UEs that are equipped with radio receivers capable of receiving GNSS signals. In 3GPP specifications the term GNSS encompasses both global and regional/augmentation navigation satellite systems. Examples of global navigation satellite systems include Global Positioning System (GPS), Modernized GPS, Galileo, GLONASS, and BeiDou Navigation Satellite System (BDS). Regional navigation satellite systems include Quasi Zenith Satellite System (QZSS) while some augmentation systems are classified under the generic term of Space Based Augmentation Systems (SBAS) and provide regional augmentation services. In this concept, different GNSSs (e.g. GPS, Galileo, etc.) can be used separately or in combination to determine the location of a UE.

Barometric pressure sensor positioning: The barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method can be combined with other positioning methods to determine the 3D position of the UE.

Wireless Local Area Network (WLAN) positioning: The WLAN positioning method makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server to determine its location.

Bluetooth positioning: The Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g. WLAN) to improve positioning accuracy of the UE.

TBS positioning: A TBS consists of a network of ground-based transmitters, broadcasting signals only for positioning purposes. The current type of TBS positioning signals are the MBS (Metropolitan Beacon System) signals and PRS (Technical Specification (TS) 36.211 [4]). The UE measures received TBS signals, optionally aided by assistance data, to calculate its location or to send measurements to the positioning server for position calculation.

Motion sensor positioning: The motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method can be used with other positioning methods for hybrid positioning.

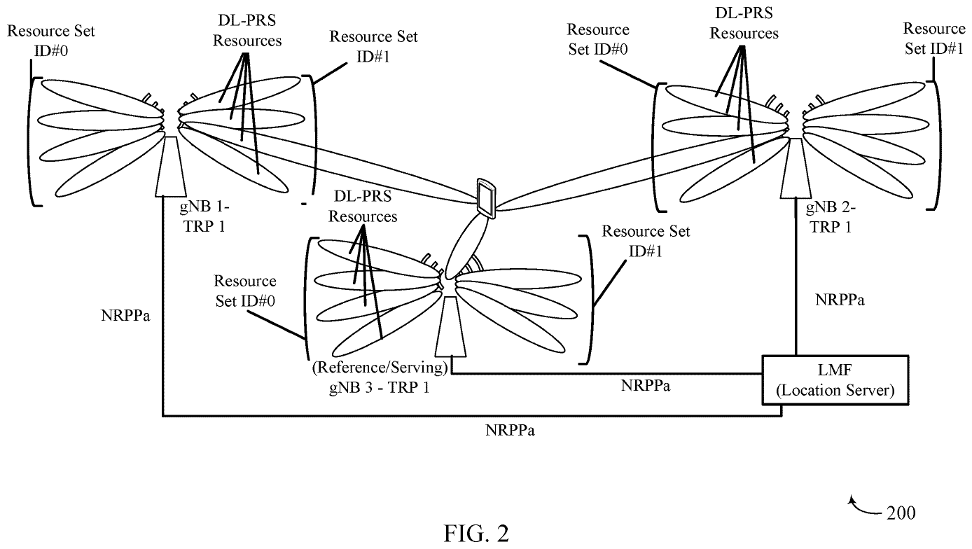

FIG. 2 illustrates a system 200 in which positioning reference signals can be utilized to obtain positioning measurements. For instance, PRS can be transmitted by different base stations (serving and neighboring) using narrow beams over FR1 and FR2, which can be different when compared to LTE where the PRS can be transmitted across the whole cell. The PRS can be locally associated with a PRS Resource identifier (ID) and Resource Set ID for a base station (TRP). Similarly, UE positioning measurements such as RSTD and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

Table 2 and Table 3 show the reference signal to measurements mapping used for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, Inertial Measurement Unit (IMU) sensor, WLAN and Bluetooth technologies for performing target device (UE) positioning.

TABLE 2
UE Measurements to enable RAT-dependent
positioning techniques

| | | To facilitate support |
|---|---|---|
| DL/UL Reference | | of the following |
| Signals | UE Measurements | positioning techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS/Rel. 16 | UE Rx-Tx time | Multi-RTT |
| SRS for positioning | difference | |
| Rel. 15 SSB/CSI- | SS-RSRP(RSRP for | E-CID |
| reference signal (RS) | RRM), SS-RSRQ(for | |
| for Radio Resource | RRM), CSI-RSRP (for | |
| Management (RRM) | RRM), CSI-RSRQ (for | |
| | RRM), SS-RSRP | |
| | (for RRM) | |

TABLE 3
gNB Measurements to enable RAT-
dependent positioning techniques

| | | To facilitate support |
|---|---|---|
| DL/UL Reference | gNB | of the following |
| Signals | Measurements | positioning techniques |
| Rel. 16 SRS for | UL RTOA | UL-TDOA |
| positioning | | |
| Rel. 16 SRS for | UL SRS-RSRP | UL-TDOA, UL-AoA, |
| positioning | | Multi-RTT |
| Rel. 16 SRS for | gNB Rx-Tx time | Multi-RTT |
| positioning, Rel. | difference | |
| 16 DL PRS | | |
| Rel. 16 SRS for | AoA and ZoA | UL-AoA, Multi-RTT |
| positioning | | |

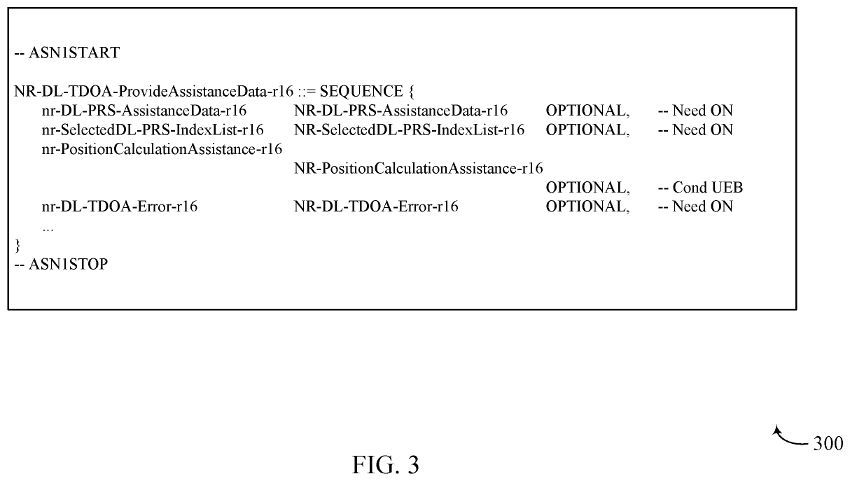

In some wireless communications scenarios, UE measurements have been defined which are applicable to DL-based positioning techniques. For instance, FIG. 3 illustrates an example information element 300 that represents an example of DL-TDOA assistance data. The IE 300, for example, represents an NR-DL-TDOA-ProvideAssistanceData IE that can be used by the location server to provide assistance data to enable UE-assisted and UE-based NR downlink TDOA. It may also be used to provide NR DL TDOA positioning specific error reason.

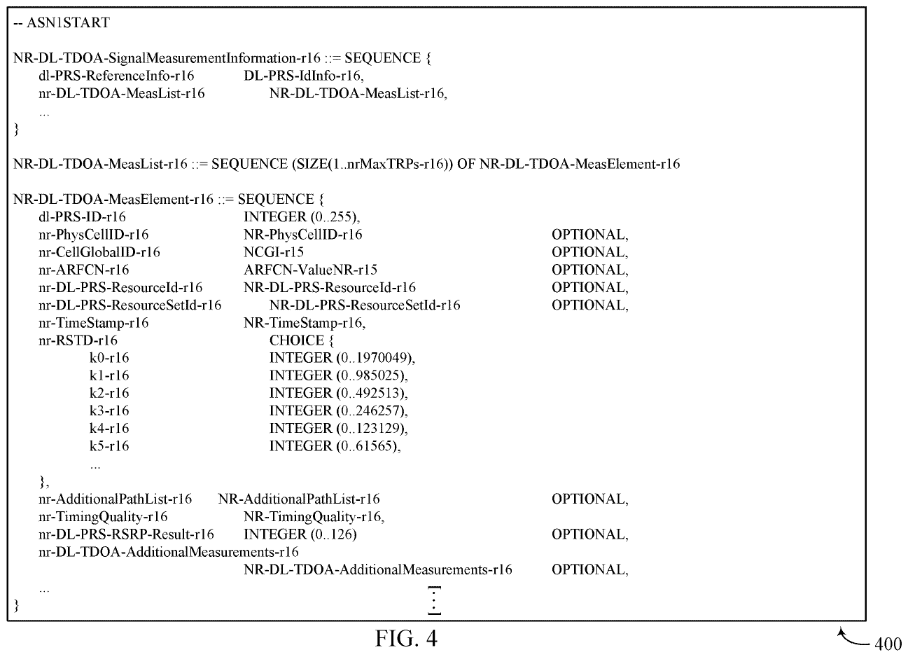

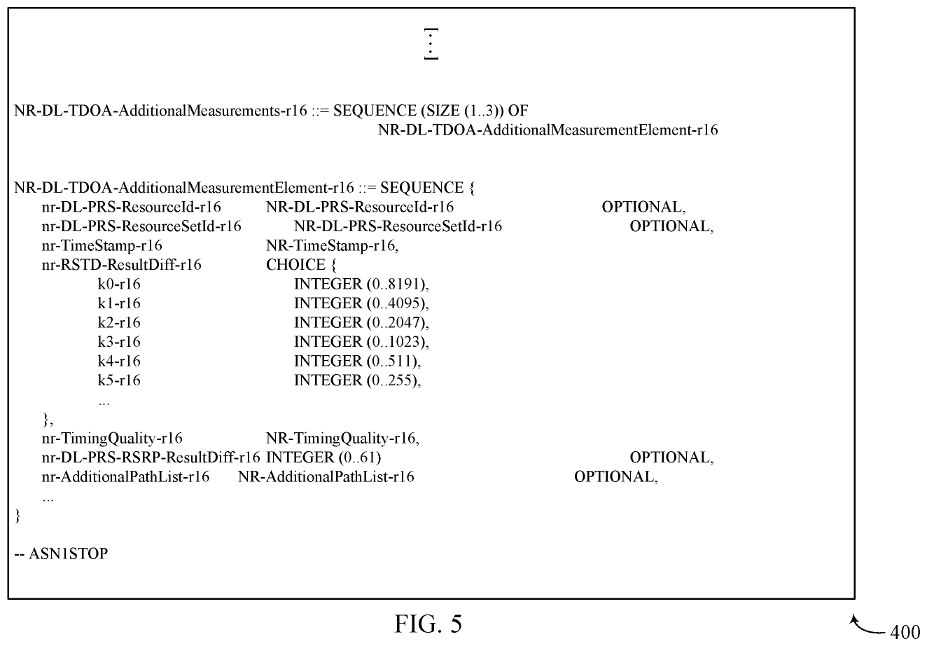

FIGS. 4 and 5 illustrate different portions of an example information element 400 that can be used for a DL-TDOA measurement report. The IE 400, for instance, represents an NR-DL-TDOA-SignalMeasurementInformation IE that can be used by the target device to provide NR-DL TDOA measurements to the location server. The measurements are provided as a list of TRPs, where the first TRP in the list is used as reference TRP in case RSTD measurements are reported. The first TRP in the list may or may not be the reference TRP indicated in the NR-DL-PRS-AssistanceData. Furthermore, the target device selects a reference resource per TRP, and compiles the measurements per TRP based on the selected reference resource.

For RAT-dependent positioning measurements, different DL measurements including DL PRS-RSRP, DL RSTD and UE Rx-Tx Time Difference used for the supported RAT-dependent positioning techniques are shown in Table 4 below. For instance, the following measurement configurations are specified [TS38.215]:
4 Pair of DL RSTD measurements can be performed per pair of cells. Each measurement is performed between a different pair of DL PRS Resources/Resource Sets with a single reference timing.
8 DL PRS RSRP measurements can be performed on different DL PRS resources from the same cell.

TABLE 4
DL Measurements required for DL-based positioning methods [TS38.215]
DL PRS reference signal received power (DL PRS-RSRP)

| | |
|---|---|
| Definition | DL PRS reference signal received power (DL PRS-RSRP), is defined as the |
| | linear average over the power contributions (in [W]) of the resource elements |
| | that carry DL PRS reference signals configured for RSRP measurements within |
| | the considered measurement frequency bandwidth. |
| | For frequency range 1, the reference point for the DL PRS-RSRP can be the |
| | antenna connector of the UE. For frequency range 2, DL PRS-RSRP can be |
| | measured based on the combined signal from antenna elements corresponding |
| | to a given receiver branch. For frequency range 1 and 2, if receiver diversity is |
| | in use by the UE, the reported DL PRS-RSRP value cannot be lower than the |
| | corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe received |
| | from positioning node j. |
| | Multiple DL PRS resources can be used to determine the start of one subframe |
| | from a positioning node. |
| | For frequency range 1, the reference point for the DL RSTD can be the antenna |
| | connector of the UE. For frequency range 2, the reference point for the DL |
| | RSTD can be the antenna of the UE. |
| Applicable for | RRC_CONNECTED intra-frequency |
| | RRC_CONNECTED inter-frequency |

UE Rx - Tx time difference

| | |
|---|---|
| Definition | The UE Rx - Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for T_{UE-RX} measurement can be the |
| | Rx antenna connector of the UE and the reference point for T_{UE-TX} measurement |
| | can be the Tx antenna connector of the UE. For frequency range 2, the reference |
| | point for T_{UE-RX} measurement can be the Rx antenna of the UE and the |
| | reference point for T_{UE-TX} measurement can be the Tx antenna of the UE. |
| Applicable for | RRC_CONNECTED intra-frequency |
| | RRC_CONNECTED inter-frequency |

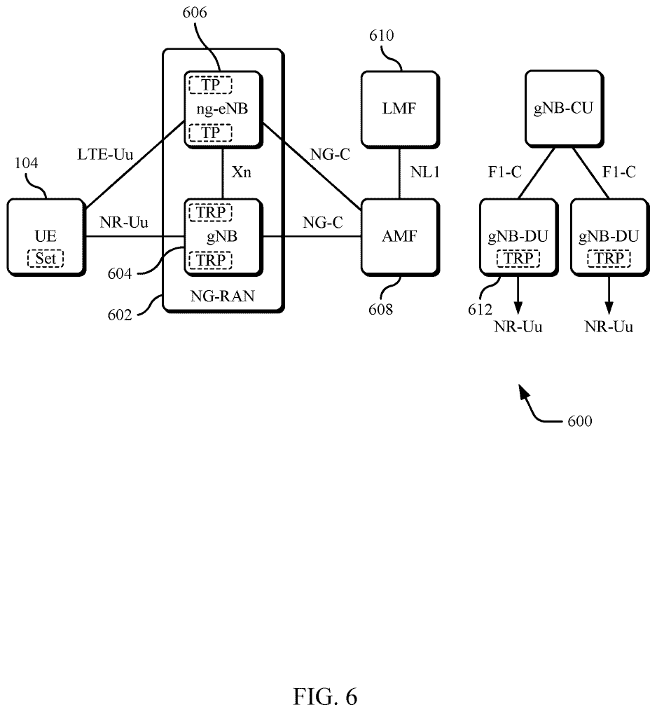

FIG. 6 illustrates an example architecture 600 applicable to NG-RAN 602 for UE positioning. The NG-RAN 602 is capable of supporting both types of interfaces LTE-Uu and NR-Uu, and the gNB 604 may be implemented in an NTN architecture. The gNB 604 and an LTE next generation evolved NodeB (ng-eNB) 606 are connected by a Xn backhaul interface. The access and mobility management function (AMF) 608 may be transparent, or bypassed in an NTN architecture, and the LMF 610 provides the positioning techniques and configuration for UE positioning.

The AMF 608 may receive a request for some location service associated with a particular target UE 104 from another entity (e.g., a gateway mobile location center (GMLC) or UE), or the AMF itself decides to initiate some location service on behalf of a particular target UE, such as for an IP multimedia subsystem (IMS) emergency call from the UE. The AMF 608 then sends a location services request to the LMF 610. The LMF 610 processes the location services request which may include transferring assistance data to the target UE 104 to assist with UE-based and/or UE-assisted positioning and/or may include positioning of the target UE. The LMF 610 then returns the result of the location service back to the AMF 608 (e.g., a position estimate for the UE 104). In the case of a location service requested by an entity other than the AMF (e.g., requested by a GMLC or UE), the AMF 608 returns the location service result to this entity.

An NG-RAN node may control several TRPs and/or TPs, such as remote radio heads, or downlink PRS-only TPs for support of PRS-based TBS. A LMF 610 may have a proprietary signaling connection to an enhanced serving mobile location center (E-SMLC), which may enable the LMF 610 to access information from an evolved universal terrestrial radio access network (E-UTRAN) (e.g. to support the observed time difference of arrival (OTDOA) for a E-UTRA positioning method using downlink measurements obtained by a target UE of signals from next generation evolved NodeBs (ng-eNBs) and/or PRS-only TPs in E-UTRAN). A LMF 610 may have a proprietary signaling connection to a SUPL location platform (SLP). The SLP is the secure user plane location (SUPL) entity responsible for positioning over the user plane. In the case of a split gNB architecture, a gNB-DU 612 may include TRP functionality, where the TRP functionality may support functions for a TP, reference point (RP), or both. A gNB-DU 612 that includes TRP functionality does not need to offer cell services.

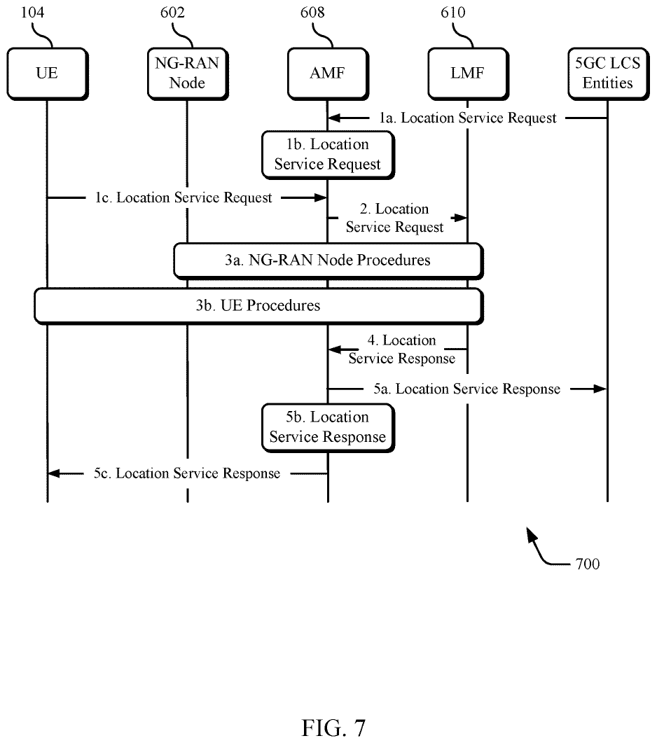

FIG. 7 illustrates a sequence 700 of signaling events applicable to the UE 104, the NG-RAN 602, the AMF 608, and the LMF 610 for any location service. When the AMF 608 receives a location service request (LSR), and the UE 104 is in a connection management (CM)-idle state (CM-IDLE) state, the AMF 608 performs a network triggered service request in order to establish a signaling connection with the UE and assigns a specific serving gNB or next generation evolved NodeB (ng-eNB). The UE is assumed to be in a connected mode before the beginning of the signaling shown in the figure (i.e., signaling that may be needed to bring the UE to the connected mode prior to step 1a is not shown). However, the signaling connection may be later released, such as by the NG-RAN 602 node as a result of signaling and data inactivity while positioning is still ongoing. Additionally, the NG-RAN 602 node represents any combination of NTSs in an NTN, including a network architecture with a TN and NTN gNB, and/or a network architecture that is fully an NTN with NG-RAN architecture.
At step 1, either step 1a, step 1b, or step 1c is performed. At step 1a, an entity in the 5GC, such as a GMLC, requests a location service for positioning a target UE 104 to the serving AMF 608. Alternatively at step 1b, the serving AMF 608 for the target UE 104 determines the need for a location service (e.g. to locate the UE for an emergency call). Alternatively at step 1c, the UE 104 requests a location service, such as for the positioning or delivery of assistance data, to the serving AMF 608 at the non-access-stratum (NAS) level.
At step 2, the AMF 608 transfers the location service request to the LMF 610. At step 3a, the LMF 610 instigates location procedures with the serving and possibly neighboring next generation evolved NodeB (ng-eNB) or gNB in the NG-RAN 602, such as to obtain positioning measurements or assistance data. In addition to step 3a or alternatively (instead of step 3a), at step 3b, the LMF 610 instigates location procedures with the UE 104, such as to obtain a location estimate or positioning measurements, or to transfer location assistance data to the UE.
At step 4, the LMF 610 provides a location service response to the AMF 608 and includes any needed results, such as a success or failure indication and, if requested and obtained, a location estimate for the UE 104. At step 5a (if step 1a was performed), the AMF 608 returns a location service response to the 5GC entity in step 1a and includes any needed results, such as a location estimate for the UE 104. At step 5b (if step 1b occurred), the AMF 608 uses the location service response received in step 4 to assist the service that triggered this in step 1b, such as to provide a location estimate associated with an emergency call to a GMLC. At step 5c (if step 1c was performed), the AMF 608 returns a location service response to the UE 104 and includes any needed results, such as a location estimate for the UE.

In aspects of signal isolation using polarization in an NTN, the location procedures applicable to NG-RAN occur in steps 3a and 3b, which supports the configurations and reporting for communication between the LMF 610 and the UE 104 to enable an NTN level positioning. The steps 3a and 3b may involve the use of different positioning methods (also referred to herein as positioning techniques or positioning procedures) to obtain location related measurements for a target UE, and from these, the UE computes a location estimate and additional positioning assistance information.

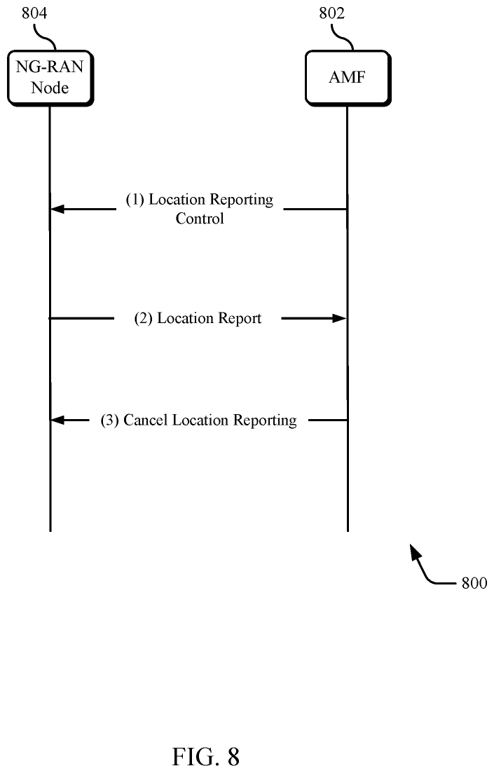

FIG. 8 illustrates an example procedure 800 for NG-RAN location reporting. The procedure 800 can be used by an AMF 802 to request an NG-RAN node 804 to report where a UE is currently located when the target UE is in CM-CONNECTED state. The need for the NG-RAN node 804 to continue reporting can terminate when the UE transitions to CM-IDLE and/or the AMF 802 sends cancel indication to NG-RAN node 804. The procedure 800 may be used for services that require accurate cell identification (e.g. emergency services, lawful intercept, charging) and/or for subscription to the service by other NFs. When Dual Connectivity is activated, PSCell information may be reported if requested by the AMF 802.

At (1) the AMF sends a location reporting control message to the NG-RAN node 804. The location reporting control message can identify the UE for which reports are requested and can include reporting type and location reporting level. The location reporting control message may also include area of interest and request reference ID. Location reporting level can be tracking area identity (TAI)+Cell Identity. Reporting type indicates whether the message is intended to trigger a single standalone report about the current Cell Identity serving the UE or start the NG-RAN node 804 to report whenever the UE changes cell, or ask the NG-RAN node 804 to report whenever the UE moves out or into the area of interest. If the reporting type indicates to report whenever the UE changes cell and if PScell reporting is requested and Dual Connectivity is in use, the Master RAN node can also report to the AMF 802 when the PSCell changes. If the reporting type indicates to start the NG-RAN node 804 to report when the UE moves out of or into the area of interest, the AMF 802 can also provide the requested area of interest information in the location reporting control message. The AMF 802 may include a Request Reference ID in the location report control message to identify the request of reporting for an area of interest. If multiple areas of interest are included in the message, the request reference ID identifies each area of interest.

At (2) the NR-RAN node 804 sends a location report to the AMF 802. The location report, for instance, includes UE location, UE presence in area of interest, request reference ID, timestamp, etc. The location report message informs the AMF 802 about the location of the UE which can be represented as the requested location reporting level. If PSCell reporting is requested and Dual Connectivity is activated, then the Master NG-RAN node can also include the PSCell ID. With NR satellite access, cell and TAI reporting by NG-RAN refer to a fixed cell and fixed TA in which a UE is geographically located. As part of the user location information, NG-RAN can also report one or more TACs for the selected public land mobile network (PLMN) such as described in TS 38.413 [10].

When the UE is in CM-CONNECTED with RRC Inactive state, if the NG-RAN node 804 has received location reporting control message from the AMF 802 with the reporting type indicating single stand-alone report, the NG-RAN node 804 can perform NG-RAN paging before reporting the location to the AMF 802. The NG-RAN node 804 can send the location report promptly and may not wait to attempt to create a Dual Connectivity configuration. However, if PSCell reporting is requested and the PSCell ID is known to the Master RAN node, then it can be included in the location report. In the case of RAN paging failure, the RAN reports a UE's last known location with time stamp.

When the UE is in CM-CONNECTED with RRC Inactive state, if the NG-RAN node 804 has received location reporting control message from the AMF 802 with the reporting type indicating continuous reporting whenever the UE changes cell, the NG-RAN node 804 can send a location report message to the AMF 802 including the UE's last known location with time stamp. If the UE was using Dual Connectivity immediately before entering CM-CONNECTED with RRC Inactive state and PSCell reporting is requested, then the location report can also include the PSCell ID.

When a UE is in CM-CONNECTED, if the NG-RAN node 804 has received location reporting control message from the AMF 802 with the reporting type of area of interest based reporting, the NG-RAN node 804 can track the UE presence in an area of interest and send a location report message to the AMF 802 including the UE presence in the area of interest (i.e. IN, OUT, or UNKNOWN) and the UE's current location (including the PSCell ID if PSCell reporting is requested and Dual Connectivity is activated) when the UE is in RRC Connected state, or, when the UE is in RRC Inactive state, the UE's last known location (including the PSCell ID if PSCell reporting is requested and the UE was using Dual Connectivity immediately before entering CM-CONNECTED with RRC Inactive state) with time stamp if the NG-RAN node 804 determines that the UE presence in the area of interest is different from the last one reported. When the NG-RAN node 804 detects that the UE has moved out of or into multiple areas of interest, it sends multiple pairs of UE presence in the area of interest and the request reference ID in one location report message to the AMF 802. If the UE transitions from RRC Inactive state to RRC Connected state, the NG-RAN node 804 can check the latest location (including the PSCell ID if PSCell reporting is requested and Dual Connectivity is activated) of the UE and follow the rules when the UE is in RRC Connected.

The AMF 802 may receive a location report even if the UE presence in an area of interest is not changed. The AMF 802 can store a latest received PSCell ID with its associated timestamp. The AMF 802 can store the latest received PSCell ID with its associated timestamp, when available.

At (3) the AMF 802 can send a cancel location reporting message to inform the NG-RAN node 804 that it is to terminate the location reporting for a given UE corresponding to the reporting type or the location reporting for area of interest indicated by request reference ID. This message can be used when the reporting type was requested for continuously reporting or for the area of interest. The AMF 802 may include the request reference ID which indicates the requested location reporting control for the area of interest, and the NG-RAN node 804 can terminate the location reporting for the area of interest. Location reporting related information of a source NG-RAN node can be transferred to the target NG-RAN node during Xn handover.

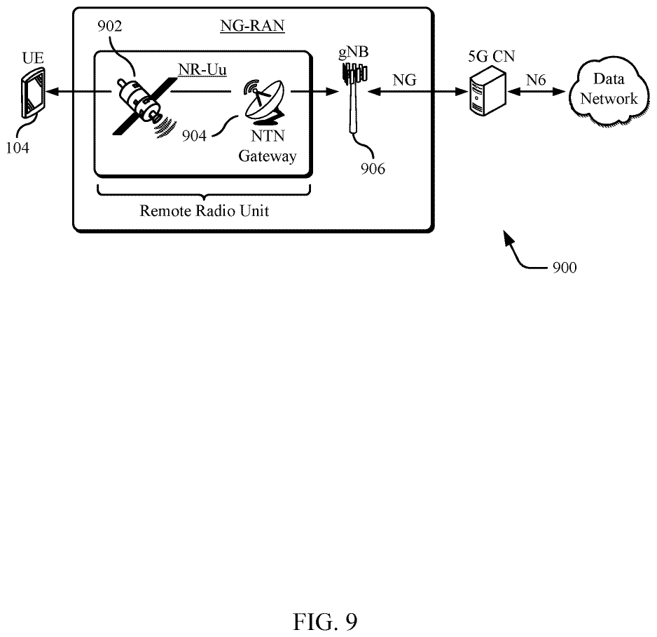

FIG. 9 illustrates a transparent satellite-based NG-RAN architecture 900. The satellite payload implements frequency conversion and a radio frequency amplifier in both the uplink and downlink directions, and it corresponds to an analogue RF repeater. Hence, the satellite 902 (e.g., a network entity 102) can repeat the NR-Uu radio interface from the feeder link, between an NTN gateway 904 and the satellite, to the service link between the satellite and the UE 104 (and vice-versa). The satellite radio interface (SRI) on the feeder link is the NR-Uu, meaning that the satellite does not terminate the NR-Uu radio interface. The NTN gateway 904 may support all of the necessary functions to forward the signal of the NR-Uu interface, and different transparent satellites may be connected to the same gNB 906 on the ground. Note that while several gNBs may access a single satellite payload, the illustration and description is simplified to the one gNB 906 accessing the satellite payload, without loss of generality.

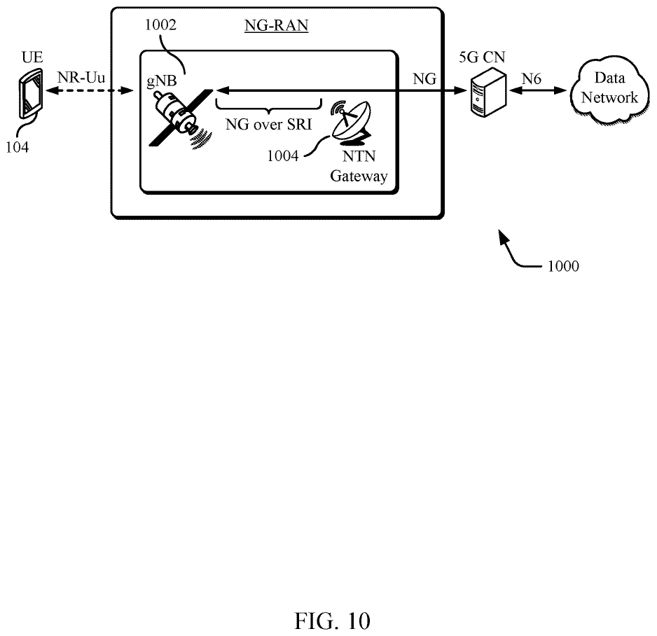

FIG. 10 illustrates a regenerative satellite-based NG-RAN architecture 1000, such as a regenerative satellite without an ISL, and with a gNB-processed payload. The NG-RAN logical architecture may be used as baseline for an NTN. The satellite payload implements regeneration of the signals received from ground-based network nodes. In this architecture 1000, the NR-Uu radio interface is implemented on the service link between the UE 104 and a satellite 1002 (e.g., network entity 102), and the SRI is implemented on the feeder link between the NTN gateway 1004 and the satellite 1002. The SRI is a transport link between the NTN gateway 1004 and the satellite.

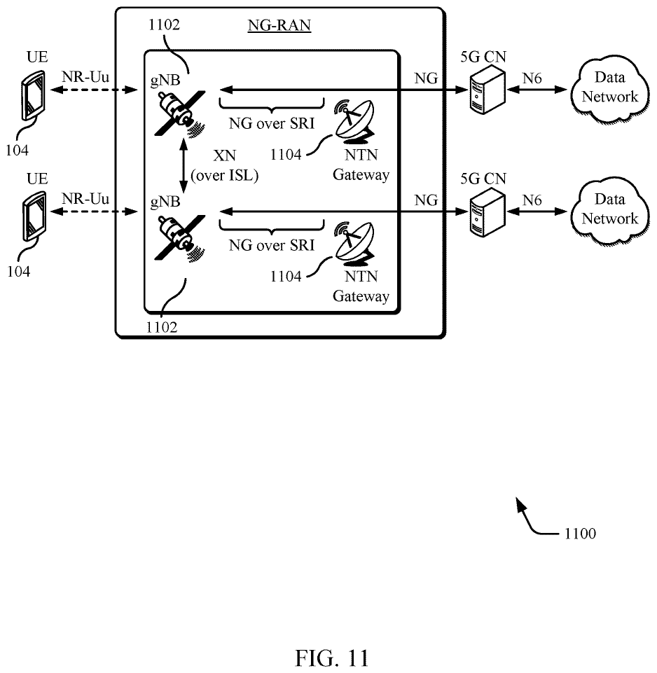

FIG. 11 illustrates another example of a regenerative satellite-based NG-RAN architecture 1100, such as a regenerative satellite system with an ISL. The ISL is a transport link, such as a radio interface or an optical interface, between satellites 1102 (e.g., network entities 102). The NTN gateway 1104 is a transport network layer node and supports all necessary transport protocols. In this architecture 1100, a UE 104 that is served by a gNB onboard a satellite could access the 5GCN via the ISL. In implementations, the gNB onboard different satellites may be connected to the same 5GCN on the ground, and if a satellite hosts more than one gNB, the same SRI may be used to transport all the corresponding NG interface instances. In this architecture, the protocol stack of the SRI is used to transport the UE user plane between a satellite 1102 and an NTN gateway 1104. The user protocol data units (PDUs) are transported over general packet radio service (GPRS) tunneling protocol (GTP) user plane (GTP-U) tunnels between the 5GCN and the onboard gNB, via the NTN gateway 1104. The NG-AP is transported over stream control transmission protocol (SCTP), between the 5GCN and the onboard gNB via the NTN gateway. The NAS protocol is also transported by the NG-AP protocol, between the 5GCN and the onboard gNB, via the NTN gateway.

Accordingly, solutions are provided in this disclosure to enhance timing-based positioning methods in NTN. In this discussion, various implementations may be implemented in combination with each other to enhance timing-based positioning methods for NTN. Further, a positioning-related reference signal may be referred to as a reference signal used for positioning procedures/purposes in order to estimate a target-UE's location, e.g., PRS, and/or based on existing reference signals such as CSI-RS or SRS; a target-UE may be referred to as the device/entity to be localized/positioned. In various implementations, the term ‘PRS’ may refer to any signal such as a reference signal, which may or may not be used primarily for positioning. Further, references made to position/location information may refer to an absolute position, relative position with respect to another node/entity, ranging in terms of distance, ranging in terms of direction, and/or combinations thereof.

In implementations, location estimate determination is utilized with measurements from a network that employs a single satellite and a multi-satellite connection to a target-UE. Further, changes in a current definition of Multi-RTT measurements may be implemented including gNB Rx-Tx time difference and UE Rx-Tx time difference measurements, and changes in behavior for performing measurements with new input parameters, such as in cases of transparent payload and single satellite.

In implementations, for multi-RTT measurements with single satellite, the RTT measurements arising from the service link can be considered in order to calculate the gNB Rx-Tx difference, as compared to the time difference between gNB on ground and a satellite, e.g., via a gateway.

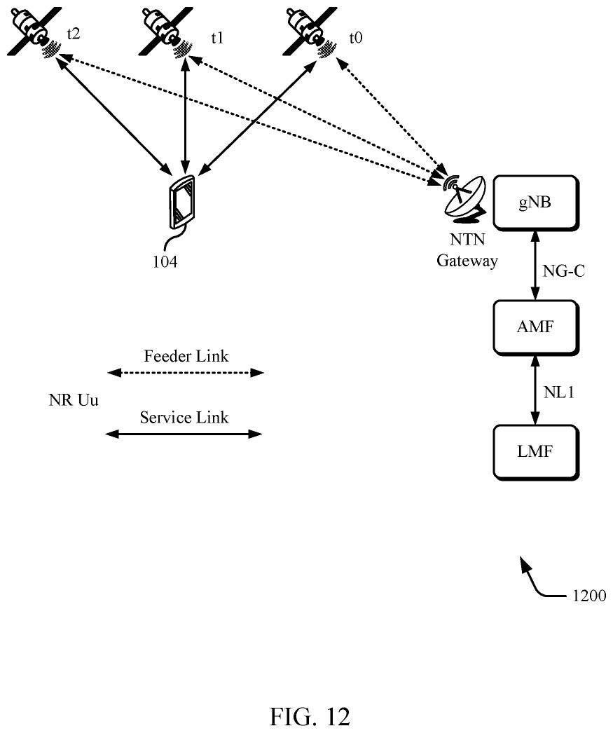

FIG. 12 illustrates a system 1200 that supports device positioning in NTN in accordance with aspects of the present disclosure. The system 1200, for instance, illustrates the Rx-Tx time differences in an NTN scenario including propagation delays characterized by the service link and feeder link.

Implementations also enable gNB Rx-Tx measurements for multi-RTT for NTN. For instance, if an NG-RAN node is part of an NTN or hybrid TN-NTN system and the NG-RAN node receives TRP measurement request for gNB Rx-Tx time difference from a location server (e.g., via NRPPa Positioning Measurement Request message), the NG-RAN node may assume to calculate the satellite Rx-Tx difference (e.g., assuming satellite as TRP) and report this value back as the true gNB Rx-Tx Time difference, where satellite Rx-Tx difference can be regarded as the time difference from when a plurality of DL-PRS are transmitted from the satellite and a plurality UL-SRS received at the same satellite node. The NG-RAN node may include one or more of the satellite, gateway, and/or gNB on the ground.

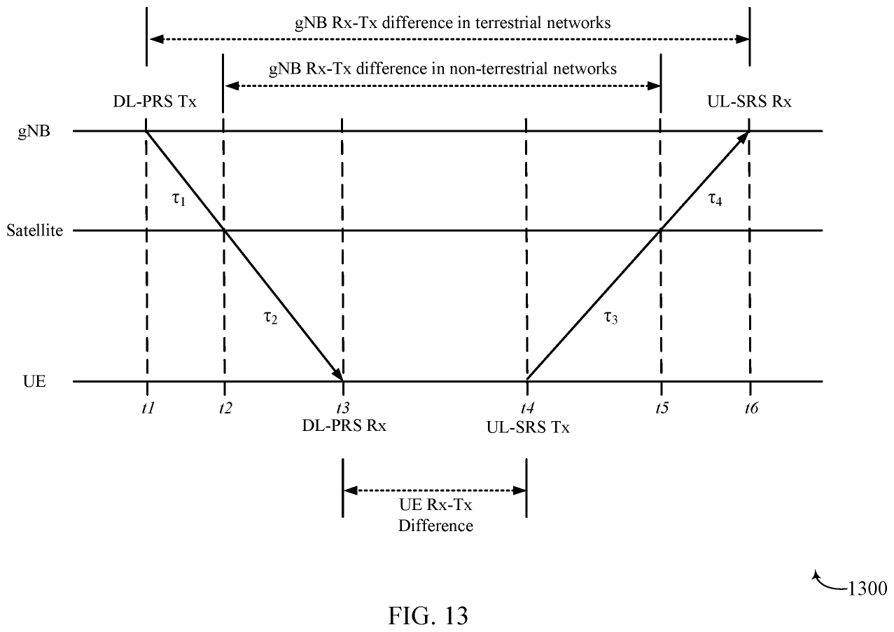

FIG. 13 illustrates a system 1300 that supports device positioning in NTN in accordance with aspects of the present disclosure. In the system 1300 t5−t2 time (e.g., a time difference on service link) may be considered as a true gNB Rx-Tx time difference measurement. In scenarios of transparent payload, the gNB may calculate the time difference from DL-PRS transmission to UL-SRS reception (16−t1 time in the system 1300) and may also calculate the feeder link delays for transmission and reception (e.g., τ₁ and τ₄ in the system 1300) based on satellite ephemeris information. The gNB may subtract the feeder link delays from the time difference of DL-PRS transmission and UL-SRS reception and report back the service link difference time as gNB Rx-Tx time difference measurement in the measurement report. In at least one implementation a field may be used to indicate to the location server that a time difference report is based on the time difference of the service links. Alternatively or additionally a field may be used to indicate to the location server that the time difference report is based on a time difference of the service and feeder links and/or time difference of the feeder links.

In implementations, the LMF may further process the gNB Rx-Tx time difference measurements with the knowledge of the NTN assistance information including feeder link delays, satellite ephemeris information, or combination thereof based on a prior request and response message exchange with the NG-RAN node and/or gNB. In implementations, these parameters may be updated on an aperiodic, event-triggered or periodic basis such as depending on the propagation delay environment, satellite position, target-UE location, or combinations thereof. The LMF may receive the gNB Rx-Tx time difference measurements in a similar manner to TNs and may further perform post-processing of these measurements based on the additional NTN assistance information such as described above.

In implementations, if an NG-RAN node is of an NTN or a hybrid TN-NTN system and the NG-RAN node receives a plurality of TRP measurement requests for gNB Rx-Tx time difference from a location server (e.g., via NRPPa), the NG-RAN node may report back the time difference when the configured plurality of DL-PRS are transmitted from the gNB and UL-SRS received by the gNB. For instance, for an NTN system with a transparent payload, the time difference can be calculated at the gNB on ground, e.g., t6−t1 time (time difference on service link plus service link) in the system 1300. In scenarios for a regenerative payload, these measurements may be implemented in a similar manner to terrestrial networks. Alternatively or additionally, in addition to gNB Rx-Tx time difference measurements, the NG-RAN node may include following in the measurement results report: DL-PRS start transmission time; satellite ephemeris that may include satellite position, velocity, altitude at transmission time; satellite ephemeris information that may include satellite position, velocity (e.g., orbital velocity), altitude at UL-SRS reception time and/or altitude at DL-PRS start transmission time; UL-SRS reception time; etc.

In implementations, the LMF may receive the satellite ephemeris information in addition to gNB Rx-TX time difference measurements in a measurement result. The LMF can calculate the feeder link delays for transmission and reception based on the satellite ephemeris information and subtract it from the gNB Tx-Rx time difference measurements.

In implementations, the NG-RAN node includes the feeder link delays for transmission and reception (e.g., τ₁ and τ₄ in the system 1300) in the measurements result report along with gNB Rx-Tx time difference measurements. The LMF may subtract these values to compute the overall RTT. Alternatively or additionally, non-transparent PRS and/or SRS signal delays between satellite and gateway, and gateway and NG-RAN node, may also be included by the NG-RAN node measurement report to the LMF.

In implementations, a gNB may inform a location server in assistance data about the type of payload architecture, e.g., transparent payload or regenerative payload, such as using the NRPPa Assistance Information Feedback message. The assistance data may be provided based on an solicited or unsolicited request by the location server. For example, a field in TRP information may be used to indicate the payload type. The location server may indicate in the measurement request message to an NG-RAN node additional requested measurements, e.g., feeder link delays, satellite ephemeris, delays arising from the gateway, etc. In at least one implementation, even if there is no indication or request for the additional measurement data, the NG-RAN node may include this information in a measurement report. In such scenarios, the location server may subtract the feeder link delays, such as if the NG-RAN node indicates that the measurements are for a transparent payload.

In implementations, the location server may indicate to the NG-RAN node types of RTT measurements it is requesting from the NG-RAN node, e.g., in a TRP measurement request. For instance, the LMF may indicate to the gNB to report satellite Rx-Tx time difference, gNB Rx-Tx time difference, or both.

In implementations, a new reference point may be defined in which to perform gNB Rx-Tx time difference measurements. Based on this, the gNB Rx-Tx time difference with a new reference point for NTN may be defined such as indicated in the Table 5.

TABLE 1
Example modified gNB Rx-Tx time difference definitions for NTN systems

| | |
|---|---|
| NTN (gNB | The gNB Rx - Tx time difference can be defined as T_{gNB-RX} − T_{gNB-TX} |
| Rx-Tx time | Where: |
| difference) | T_{gNB-RX} is the Transmission and Reception Point (TRP) received timing of |
| Definition | uplink subframe #i containing SRS associated with UE, defined by the first |
| | detected path in time. |
| | T_{gNB-TX} is the TRP transmit timing of downlink subframe #j that is closest in |
| | time to the subframe #i received from the UE. |
| | Multiple SRS resources can be used to determine the start of one subframe |
| | containing SRS. |
| | The reference point for T_{gNB-RX} can be: |
| | for type 1-C base station TS 38.104 [9]: the Rx antenna connector, |
| | for type 1-O or 2-O base station TS 38.104 [9]: the Rx antenna (e.g., the |
| | centre location of the radiating region of the Rx antenna), |
| | for type 1-H base station TS 38.104 [9]: the Rx Transceiver Array |
| | Boundary connector. |
| | for NTN systems: the satellite Rx antenna connector |
| | for NTN systems: the satellite Rx antenna the Rx antenna (e.g., the centre |
| | location of the radiating region of the Rx antenna), |
| | for NTN systems: the satellite Rx Transceiver Array Boundary connector |
| | The reference point for T_{gNB-TX} can be: |
| | for type 1-C base station TS 38.104 [9]: the Tx antenna connector, |
| | for type 1-O or 2-O base station TS 38.104 [9]: the Tx antenna (e.g., the |
| | centre location of the radiating region of the Tx antenna), |
| | for type 1-H base station TS 38.104 [9]: the Tx Transceiver Array |
| | Boundary connector. |
| | for NTN systems: the satellite Tx antenna connector |
| | for NTN systems: the satellite Tx antenna the Tx antenna (e.g., the center |
| | location of the radiating region of the Tx antenna), |
| | for NTN systems: the satellite Tx Transceiver Array Boundary connector |
| | NOTE: Satellite system may comprise of a transparent or regenerative payload |

Implementations described herein further provide for UE Rx-Tx measurements for the multi-RTT method for NTN. For instance, the UE Rx-Tx time difference measurement may be implemented in a similar as TN for NTN and hybrid NTN-TN deployments. The UE, for example, is performing the UE Rx-Tx time difference measurement in a transparent manner and can utilize additional knowledge of the type of network deployment.

Implementations described herein further provide for RSTD measurements for a DL-TDoA method for NTN. For instance, a UE may measure the relative timing of DL-PRS between a single satellite transmission point (STP) at various time instances. In TN implementations, RSTD measurement can be defined as the DL relative timing difference between the TPⱼ and the reference TPᵢ, defined as T_{SubframeRxj}−T_{SubframeRxi}. TDoA positioning can utilize multiple reference points or anchor nodes which may be static in order to perform positioning. TDoA measurement, for instance, involves measuring the time difference between the DL PRS ToA of a signal between a reference node and another anchor node, and using that information to determine the location of the target-UE.

In implementations, the satellite mobility depending on the type of satellite can be much larger compared to a UE's movement, such as depending on the mode of transport of a UE. For example, a low earth orbiting (LEO) satellite may have a typical velocity of 7500-8500 m/s, which is orders of magnitude greater than a UE travelling in a commercial plane, e.g., 222-250 m/s. To enable DL-TDoA in a single satellite scenario, the mobility between the single satellite and the UE may be used to perform ‘virtual’ RSTD measurements based on the satellite displacement over time. In at least one implementation, different satellite on-board sensors including ephemeris data may be used to track the satellites displacement, velocity, acceleration, and/or IMU measurements such as yaw, pitch and roll.

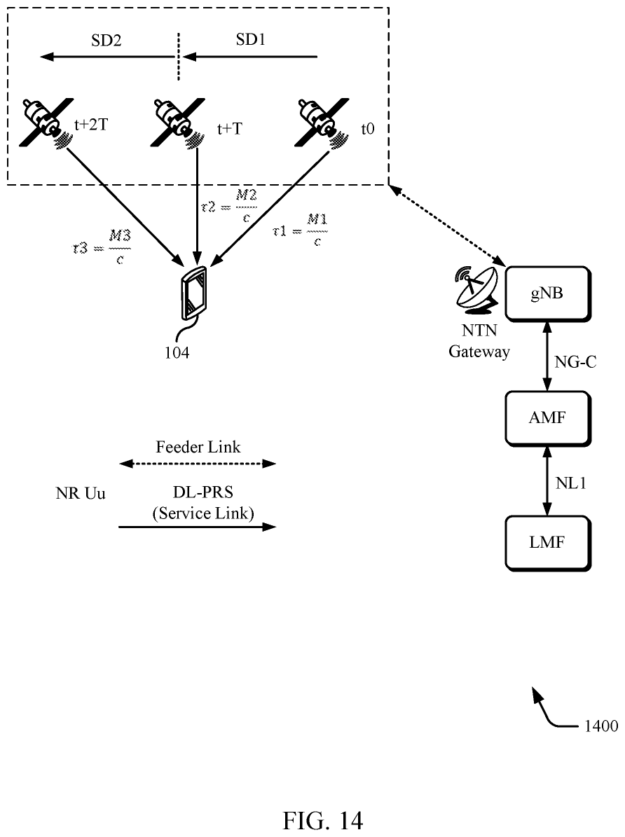

FIG. 14 illustrates a system 1400 that supports device positioning in NTN in accordance with aspects of the present disclosure. The system 1400, for instance, represents an illustration of the concept of ‘virtual’ RSTD measurements for NTN, such as using DL RSTD measurements based on satellite displacement.

In the system 1400:
τᵢ=propagation delay at each i^{th} satellite displacement
c=speed of light
Mᵢ=(Satellite-UE) distance at each i^{th} satellite displacement
SDᵢ=i^{th} satellite displacement

In implementations, NTN RSTD measurements may be performed as follows:

$${RSTD}_{1} = {OTD}_{1} + {RTD}_{1} + {ε}_{1} = \vert τ 1 - τ 3 \vert + ( t - ( t + T ) ) + {ε}_{1} \qquad ( 1 )$$

$${RSTD}_{2} = {OTD}_{2} + {RTD}_{2} + {ε}_{2} = \vert τ 2 - τ 3 \vert + ( t - ( t + 2 T ) ) + {ε}_{2} \qquad ( 2 )$$

Where OTDᵢ is the observed time difference at the i^{th} satellite displacement, where for example, in the system 1400 i=1, 2 for RSTD measurements corresponding to 2 satellite displacements, RTDᵢ is the real-time difference comprising of the transmit timing offset of DL-PRS for (t−(t+T)) for RSTD₁ and (t−(t+2T)) for RSTD₂, ε is the measurement uncertainty/error at the UE-side related to the measurement of the RSTD. In some scenarios additional errors may be incurred from the time at which the displacement is recorded to the time in which the PRS is transmitted from satellite.

In implementations, the satellite displacement can be defined as the orbital displacement of the satellite, which corresponds to the travelled arc of the satellite with a specific velocity along its orbital path. Therefore, the satellite displacement time can be equivalent to the different time instances corresponding to the different arcs along the orbital path of the satellite.

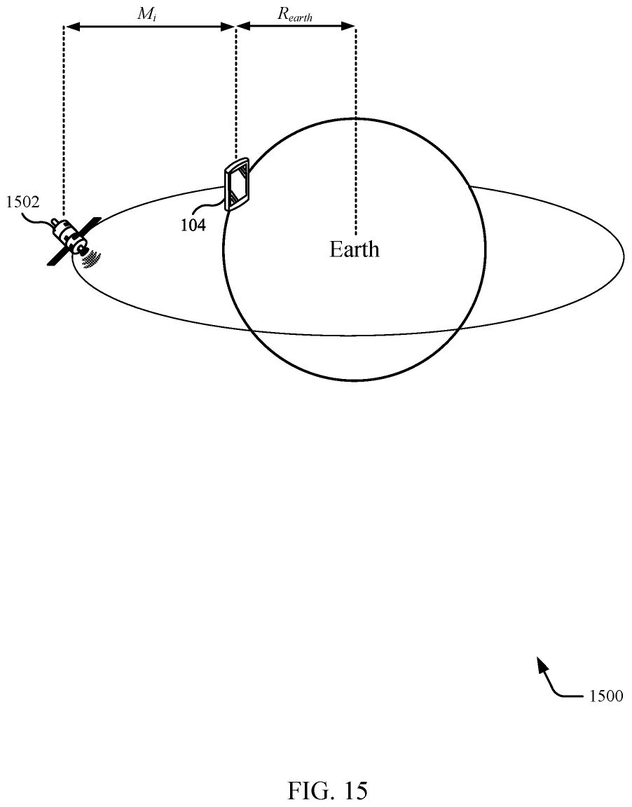

FIG. 15 illustrates a scenario 1500 that supports device positioning in NTN in accordance with aspects of the present disclosure. The scenario 1500, for example, illustrates an orbital path of a satellite 1502 considering Mᵢ and R_{Earth}. In the scenario 1500, for instance, the Mᵢ (satellite—UE 104) distance (e.g., as discussed above) is coupled with the radius of the earth such that radial orbit of the satellite 1502 (R_{Orbit}) is R_{Orbit}=Mᵢ+R_{Earth}.

In implementations, the radius of the earth is given by R_{Earth}=6.731×10⁶ m and the corresponding satellite velocity (v) is given as:

$$v = \sqrt{\frac{G \times {M}_{Centre}}{{R}_{Orbit}}} \qquad ( 4 )$$

Where G is the gravitational constant, M_{Centre} is the mass of the central body about which the satellite orbits, e.g., in this case the mass of the earth. Therefore, combining the above equations, the following delay is obtained as:

$${R}_{Orbit} = \frac{G \times {M}_{Centre}}{{v}^{2}} \qquad ( 5 )$$

$${M}_{i} + {R}_{Earth} = \frac{G \times {M}_{Centre}}{{v}^{2}}$$

$${M}_{i} = \frac{G \times {M}_{Centre}}{{v}^{2}} - {R}_{Earth}$$

$${τ}_{i} = {c}^{- 1} ( \frac{G \times {M}_{Centre}}{{v}^{2}} - {R}_{Earth} )$$

The above parameters used to compute the delay in Equation (5) may be provisioned to the entity computing the delay (e.g., UE or gNB) prior to the measurement, e.g., in the case of the UE, using the LPP ProvideAssistanceData message.

In implementations, time t can be referred to as a reference satellite displacement time to which forthcoming satellite displacements are differenced in order to compute the RTDᵢ. Alternatively or additionally, the reference satellite displacement time may rollover to a new reference satellite displacement time corresponding to t+NT, where in at least one implementation N is a positive integer or in other implementations N can be represented as a floating point. In implementations, the NTN RTD may be signaled using, e.g., the LTE positioning protocol (LPP) ProvideAssistanceData message based on a solicited request, e.g., LPP RequestAssistanceData or based on an unsolicited request.

In implementations, the RTD can be minimized taking into account the feeder link delay, velocity of the satellite, satellite movement, etc. For example, to achieve a 1 ns reference time difference (RTD) (e.g., and synchronization error) as in some TN networks, the satellite displacement of a LEO satellite moving at 8500 m/s would be considered to be SD=8.5 μm (SD=8500 m/s×1 ns). However, for the purposes of verification within a 5-10 km area, a certain loss in positioning accuracy may be tolerated. In one example, consider a 15 kHz subcarrier spacing (SCS) with a slot duration of 1 ms, where the RSTD derive between different slots and assuming that the corresponding RTD is 1 ms for the single-satellite scenario, this would result in a satellite displacement of SD=850 m. Depending on the required accuracy, the RSTD may be defined at various granularity (e.g., based on different SCS) to ensure the desired accuracy (e.g., RSTD may be computed on a slot level as opposed to a subframe level), which may achieve various degrees timing granularity depending on the configured SCS.

In implementations it can be assumed that the OTD may vary depending on the satellite location over the horizon, which affects the accuracy of the RSTD measurement. In addition, various uncalibrated timing errors may influence the measured TOA based on the computed delay (τ). In implementations, available UE-specific timing advance (TA) may be used to derive the propagation delay (τ), which can be used to perform the RSTD measurement at each satellite displacement interval with respect to a reference satellite displacement time.

In implementations such as for a single satellite case, the RSTD measurement can defined according to Table 6 below:

TABLE 6
An example of modified RSTD time difference definition for NTN systems

| | |
|---|---|
| Definition | DL reference signal time difference (DL RSTD) is the DL relative timing |
| | difference between the Transmission Point (TP) at a satellite displacement time |
| | t + NT and the reference satellite displacement time t, defined as T_{Slot-(t+NT)} − |
| | T_{Slot-(t)}, |
| | Where: |
| | T_{Slot-(t+NT)} is the time when the UE receives the start of one PRS slot at TP t + NT |
| | time. |
| | T_{Slot-(t)} is the time when the UE receives the corresponding start of one PRS slot |
| | at TP t that is closest in time to the slot received at TP t + NT time. |
| | Multiple DL PRS resources can be used to determine the start of one slot from a |
| | TP at a particular satellite displacement time. |
| | For frequency range 1, the reference point for the DL RSTD can be the antenna |
| | connector of the UE. For frequency range 2, the reference point for the DL |
| | RSTD can be the antenna of the UE. |
| Applicable for | RRC_CONNECTED, |
| | RRC_INACTIVE |

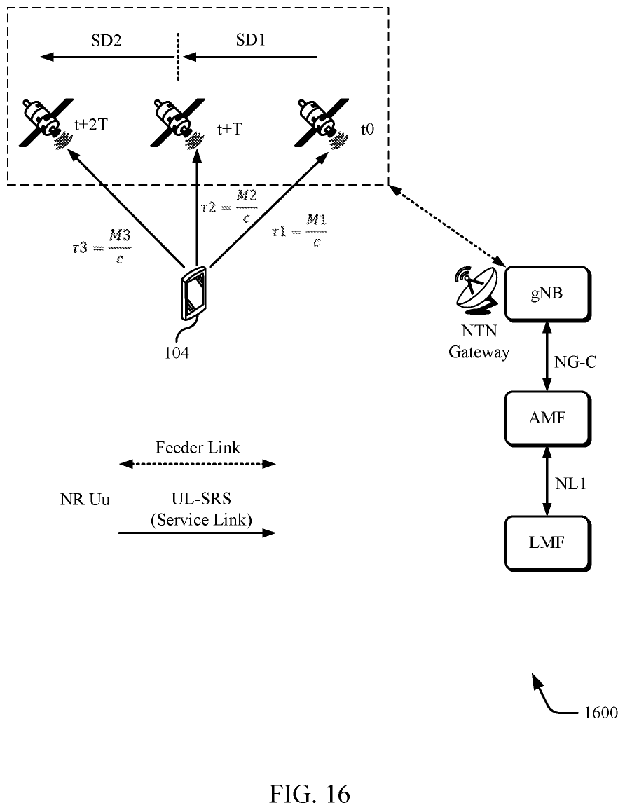

FIG. 16 illustrates a system 1600 that supports device positioning in NTN in accordance with aspects of the present disclosure. The system 1600, for instance, represents an example implementation for UL RTOA measurements based on satellite displacement, e.g., UL-RTOA measurements for an UL-TDoA method for NTN.

In implementations using the system 1600, a similar concept using the satellite displacement regarding the above-described DL RSTD measurement in the system 1400 may be applied to UL-TDoA to perform UL-RTOA measurements at the satellite side using UL-SRS. The system 1600, for instance, illustrates the concept of ‘virtual’ Relative TOA measurements for NTN based on UL-SRS.

In the system 1600:
τᵢ=propagation delay at each i^{th} satellite displacement
c=speed of light
Mᵢ=(Satellite-UE) distance at each i^{th} satellite displacement
SDᵢ=i^{th} satellite displacement

In implementations such as in the system 1600, UL-RTOA measurements may be performed at each satellite displacement time based on UL propagation delay of the SRS. The SRS may further include SRS for positioning or MIMO SRS. A target-UE may be configured to transmit SRS at each time instant corresponding to the configured satellite displacement parameters received by the target-UE via a combination of NRPPa and RRC signaling. Each of the collected and reported UL-RTOA measurements at the satellite displacement time may be used to determine the location of the target-UE within a certain accuracy. Alternatively or additionally, the above described measurements in this particular implementation may also be applicable to the multi-satellite scenario in one form or another. Alternatively or additionally, the RTOA may be computed using the parameters including the orbital velocity, gravitational constant, mass of a central body, e.g., earth, radius of the earth, and speed of light as defined in Equation (5).

Implementations described herein further enable reporting and measurement gap configuration aspects for time-based positioning methods in NTN. For instance, if multi-RTT measurements are to be performed for a single satellite, a location server may configure a gNB to report multiple gNB Rx-Tx time difference measurements at various configured times in order to leverage the single-satellite case for Multi-RTT. In at least one implementation, an LMF may request the gNB Rx-Tx time difference measurements at configured periodicities or intervals, which may be based on the satellite ephemeris information including satellite movement. Table 7 is an example implementation of reporting gNB Rx-Tx time difference measurements at different time instances.

TABLE 7
An illustration of the configurable report time instances within Measurement Request IE

| | | | | | | |
|---|---|---|---|---|---|---|
| IE/Group | | | IE Type and | Semantics | | Assigned |
| Name | Presence | Range | Reference | Description | Criticality | Criticality |

| | | | | | |
|---|---|---|---|---|---|
| Report | M | ENUMERATED | | YES | reject |
| Characteristics | | (OnDemand, | | | |
| | | Periodic, | | | |
| | | NTN-report . . . ) | | | |
| Measurement | C- | ENUMERATED | The | YES | reject |
| Periodicity | ifReportCharac- | (120 ms, | codepoint | | |
| | teristicsPeriodic | 240 ms, | 120 ms, | | |
| | | 480 ms, | 240 ms, | | |
| | | 640 ms, | 480 ms, | | |
| | | 1024 ms, | 1024 ms, | | |
| | | 2048 ms, | 2048 ms, | | |
| | | 5120 ms, | 1 min, 6 min, | | |
| | | 10240 ms, | 12 min, | | |
| | | 1 min, 6 min, | 30 min, and | | |
| | | 12 min, 30 min, | 60 min are | | |
| | | 60 min, . . . , | not | | |
| | | 20480 ms, | applicable | | |
| | | 40960 ms, | | | |
| | | extended) | | | |
| NTN-report | C- | ENUMERATED | The LMF | YES | reject |
| | ifReportCharac- | {set of | may | | |
| | teristicsNTN- | configurable | configure | | |
| | report | time values} | one or more | | |
| | | | time | | |
| | | | instances at | | |
| | | | which the | | |
| | | | report may | | |
| | | | be provided. | | |
| | | | This report | | |
| | | | time | | |
| | | | instances | | |
| | | | may not be | | |
| | | | periodic. | | |

In implementations a periodic measurement with a minimum gap may also be configured. The periodicity may be uniform with the same minimum interval/gap, while in another implementation multiple reporting periodicities with different minimum intervals/gaps may also be configured in a request message. In such scenarios, the RP may be the first measurement instance. In implementations separate reporting configuration may be provided for only Multi-RTT measurements in a single satellite scenario including UE Rx-Tx and gNB Rx-Tx time difference measurements.

In implementations reporting of multiple UE Rx-Tx time difference measurements can occur in a single report with satellite ephemeris information, which can be specific to an NTN case and may not necessarily be periodic in nature.

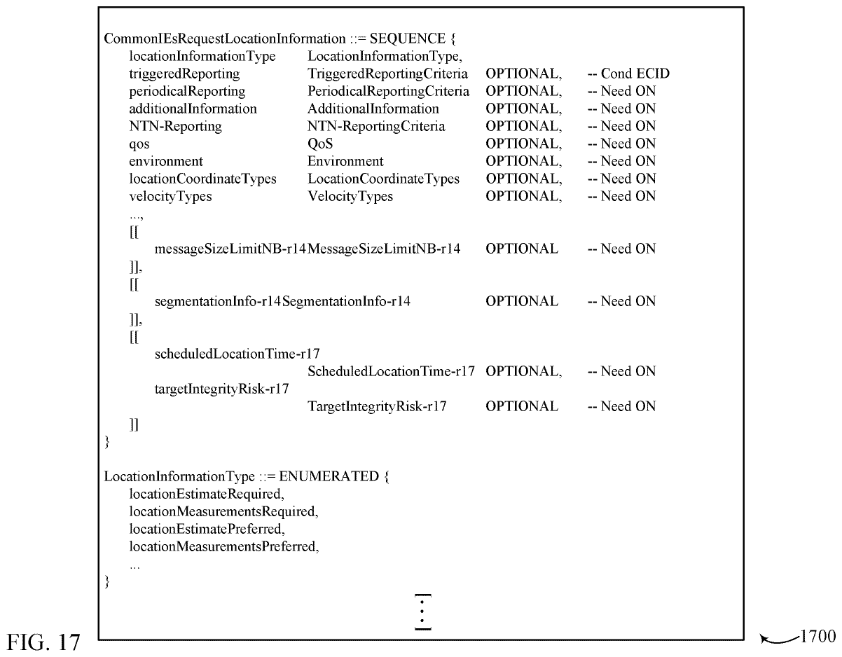

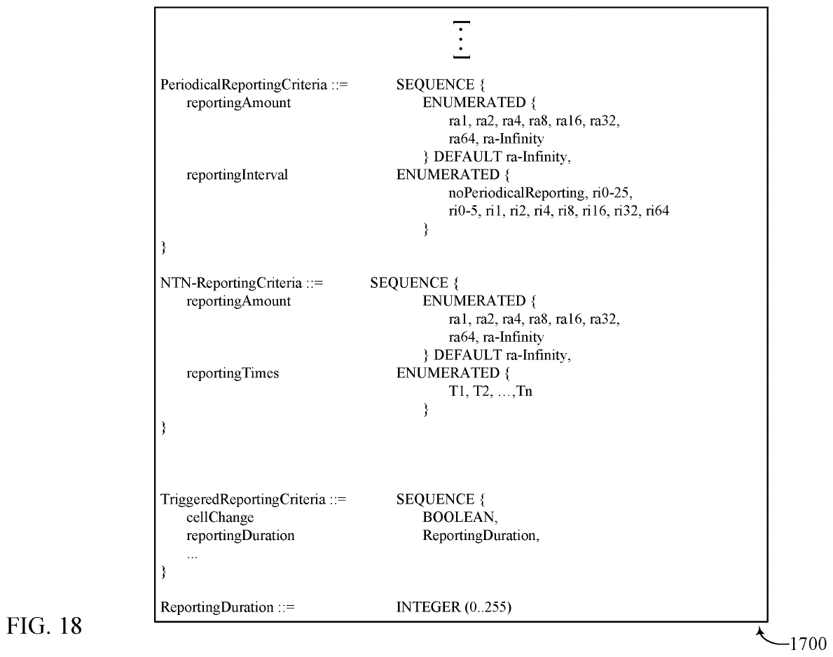

FIGS. 17 and 18 illustrate portions of an IE 1700 that supports device positioning in NTN in accordance with aspects of the present disclosure. The IE 1700, for instance, illustrates an example type of positioning reporting configuration that may be configured for NTN-specific deployments. In at least one implementation the IE 1700 represents a CommonIEsRequestLocationInformation IE. The following represent example field descriptions for the IE 1700.

CommonIEsRequestLocationInformation field descriptions

triggeredReporting
This IE indicates that triggered reporting is requested and comprises the following subfields:

| | |
|---|---|
| - | cellChange: If this field is set to TRUE, the target device provides requested location |
| | information each time the primary cell has changed. |
| - | reportingDuration: Maximum duration of triggered reporting in seconds. A value of zero is |
| | interpreted to mean an unlimited (i.e. “infinite”) duration. The target device should continue |
| | triggered reporting for the reportingDuration or until an LPP Abort or LPP Error message |
| | is received. |

The triggeredReporting field should not be included by the location server and can be ignored by
the target device if the periodicalReporting IE or responseTime IE or responseTimeNB IE is
included in CommonIEsRequestLocationInformation.
periodicalReporting
This IE indicates that periodic reporting is requested and comprises the following subfields:

| | | |
|---|---|---|
| | - | reportingAmount indicates the number of periodic location information reports requested. |
| | | Enumerated values correspond to 1, 2, 4, 8, 16, 32, 64, or infinite/indefinite number of |
| | | reports. If the reportingAmount is ‘infinite/indefinite’, the target device shou-ld continue |
| | | periodic reporting until an LPP Abort message is received. The value ‘ra1’ can not be used |
| | | by a sender. |
| - | | reportingInterval indicates the interval between location information reports and the |

response time requirement for the first location information report. Enumerated values ri0-25, ri0-
5, ri1, ri2, ri4, ri8, ri16, ri32, ri64 correspond to reporting intervals of 1, 2, 4, 8, 10, 16, 20, 32,
and 64 seconds, respectively. Measurement reports containing no measurements or no location
estimate are required when a reportingInterval expires before a target device is able to obtain new
measurements or obtain a new location estimate. The value ‘noPeriodicalReporting’ can not be
used by a sender.
NTN-ReportingCriteria
This IE indicates that NTN reporting is requested and comprises the following subfields:
reportingAmount indicates the number of NTN location information reports requested.
Enumerated values correspond to 1, 2, 4, 8, 16, 32, 64, or infinite/indefinite number of reports. If
the reportingAmount is ‘infinite/indefinite’, the target device shou-d continue NTN reporting until
an LPP Abort message is received. The value ‘ra1’ can not be used by a sender.
reportingTimes indicates that the target device is requested to obtain location measurements or
location estimates valid at a set of times T1, T2, ..., Tn. At a given time T the target UE may
report X positioning measurements, e.g., X UE Rx-Tx time difference measurements. The time T
can have the following time formats or time bases:

| utcTime provides T in UTC in the form of YYMMDDhhmmssZ. | |
|---|---|
| - | gnssTime provides T in GNSS system time of the GNSS indicated by gnss-TimeID. |

| | |
|---|---|
| - | gnss-TOD-msec specifies the GNSS TOD in 1-milli-second resolution rounded down to |
| | the nearest millisecond unit. |

| | |
|---|---|
| - | networkTime provides T in E-UTRA or NR network time. |

| | |
|---|---|
| - | lte-PhysCellId, lte-ArfcnEUTRA, lte-CellGlobalId identifies the reference cell (E- |
| | UTRA) that is used for the network time. |
| - | lte-systemFrameNumber specifies the system frame number in E-UTRA. |
| - | nr-PhysCellID, nr-ARFCN , nr-CellGlobalID identifies the reference cell (NR) that is |
| | used for the network time. |
| - | nr-SFN specifies the system frame number (SFN) in NR. |
| - | nr-Slot specifies the slot number in NR for the indicated subcarrier spacing (SCS). The |
| | total NR network time is given by nr-SFN + nr-Slot. |

| | |
|---|---|
| - | relativeTime provides T in seconds from current time, where current time is defined as the |
| | time the CommonIEsRequestLocationInformation was received. |

In implementations, a target-UE may be configured to perform the above reporting for only a subset of positioning techniques under certain scenarios, e.g., UE Rx-Tx time difference measurements with a single satellite scenario, and so forth. This may depend on the type of measurement and NTN deployment. The above reporting configuration, for instance, can be configured per RAT-dependent positioning technique, RAT-independent positioning technique, or combination thereof.

In implementations, a target UE may measure multiple UE Rx-Tx time difference measurements with an extended measurement gap configuration for an NTN use case. The extended measurement gap can enable the measurement of downlink positioning reference signals, which can be configured outside an active DL BWP. A new measurement gap (MG) configuration can be configured including a MG pattern ID, MG gap offset, MGL and MGRP for performing measurements with a longer MGL and MGRP taking into account the PRS SCS, NTN propagation delays of the service and feeder link and any required minimum time gaps between measurements. This configuration may be signaled via RRC signaling (e.g. using the RRCReconfiguration message) and a new NTN measurement gap configuration may be pre-configured with a specific activation/deactivation command sent via MAC control element (CE) or RRC signaling. An example MG configuration for NTN-specific deployments is highlighted in the following table extract:

| | Measurement | Measurement Gap |
|---|---|---|
| Gap | Gap Length | Repetition Period |
| Pattern Id | (MGL, ms) | (MGRP, ms) |
| 0 | 6 | 40 |
| 1 | 6 | 80 |
| 2 | 3 | 40 |
| . | . | . |
| . | . | . |
| . | . | . |
| 23 | 1.5 | 160 |
| 24 | 10 | 80 |
| 25 | 40 | 320 |
| 26 | 80 | 640 |
| 27 | 160 | 1280 |

In implementations, the adapted time-based positioning measurements may be measured within an active DL BWP such as when a UE is configured and activated with a priority processing window including multiple priority states. The length of the priority processing window may be subject to a UE capability. The priority processing window may then be deactivated upon competition of positioning measurements within an active DL BWP.

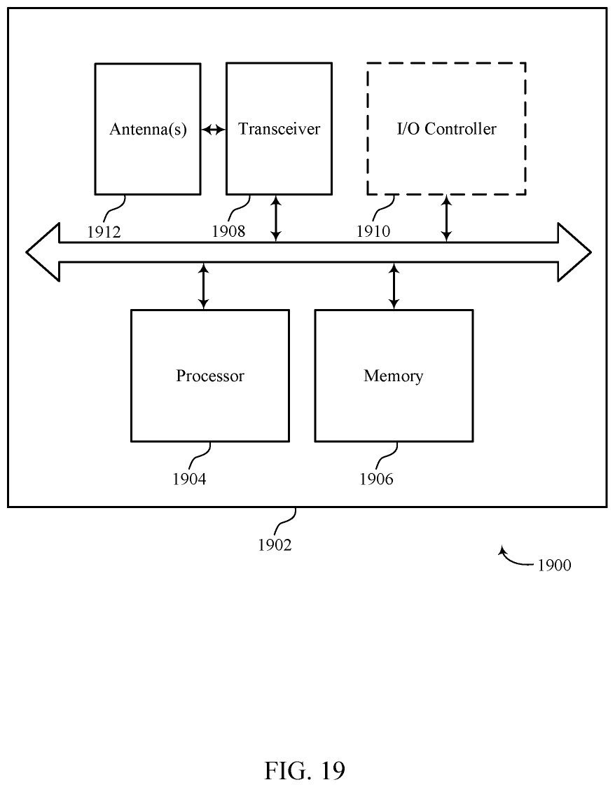

FIG. 19 illustrates an example of a block diagram 1900 of a device 1902 (e.g., an apparatus) that supports device positioning in NTN in accordance with aspects of the present disclosure. The device 1902 may be an example of UE 104 as described herein. The device 1902 may support wireless communication with one or more network entities 102, UEs 104, or any combination thereof. The device 1902 may include components for bi-directional communications including components for transmitting and receiving communications, such as a processor 1904, a memory 1906, a transceiver 1908, and an I/O controller 1910. These components may be in electronic communication or otherwise coupled (e.g., operatively, communicatively, functionally, electronically, electrically) via one or more interfaces (e.g., buses).

The processor 1904, the memory 1906, the transceiver 1908, or various combinations thereof or various components thereof may be examples of means for performing various aspects of the present disclosure as described herein. For example, the processor 1904, the memory 1906, the transceiver 1908, or various combinations or components thereof may support a method for performing one or more of the operations described herein.

In some implementations, the processor 1904, the memory 1906, the transceiver 1908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1904 and the memory 1906 coupled with the processor 1904 may be configured to perform one or more of the functions described herein (e.g., executing, by the processor 1904, instructions stored in the memory 1906). In the context of UE 104, for example, the transceiver 1908 and the processor 1904 coupled to the transceiver 1908 are configured to cause the UE 104 to perform the various described operations and/or combinations thereof.

For example, the processor 1904 and/or the transceiver 1908 may support wireless communication at the device 1902 in accordance with examples as disclosed herein. For instance, the processor 1904 and/or the transceiver 1908 may be configured as and/or otherwise support a means to receive, from a first network entity, one or more positioning measurement configurations to perform time-based positioning; receive, from a second network entity, downlink positioning reference signals at different time instances; perform one or more time-based positioning measurements based at least in part on the downlink positioning reference signals and the one or more positioning measurement configurations; and transmit, based at least in part on the one or more time-based positioning measurements, one or more positioning measurement reports to the second network entity.

Further, in some implementations, the apparatus includes a user equipment (UE), the first network entity includes a location server, and the second network entity includes a non-terrestrial network (NTN) next generation radio access network (NG-RAN) node; the one or more positioning measurement configurations include at least one of satellite link delay information, satellite ephemeris information, or satellite displacement information; to perform the one or more time-based positioning measurements, the processor is configured to cause the apparatus to perform non-terrestrial network (NTN) RSTD measurements based at least in part on an observed time difference and a real time difference of satellite displacement times; the processor is configured to cause the apparatus to perform the NTN RSTD measurements based at least in part on one or more of RSTD measurement uncertainty or RSTD measurement error.

Further, in some implementations, the processor is configured to cause the apparatus to perform the NTN RSTD measurements based at least in part on a relative timing difference between a TP at a satellite displacement time t+NT and a reference satellite displacement time t between a pair of transmission slots; the processor is configured to cause the apparatus to receive, from the first network entity, a non-terrestrial network (NTN) reporting criteria including a set of configurable time instances in which to provide positioning measurement reports; the set of configurable time instances include a number of time instances and absolute reporting times; the processor is configured to cause the apparatus to receive, from the first network entity, a non-terrestrial network (NTN) extended measurement gap configuration for performing NTN downlink positioning measurements; the NTN extended measurement gap includes at least one of a gap pattern identifier, an MGL, or an MGRP.

The processor 1904 of the device 1902, such as a UE 104, may support wireless communication in accordance with examples as disclosed herein. The processor 1904 includes at least one controller coupled with at least one memory, and the at least one controller is configured to and/or operable to cause the processor to receive, from a first network entity, one or more positioning measurement configurations to perform time-based positioning; receive, from a second network entity, downlink positioning reference signals at different time instances; perform one or more time-based positioning measurements based at least in part on the downlink positioning reference signals and the one or more positioning measurement configurations; and transmit, based at least in part on the one or more time-based positioning measurements, one or more positioning measurement reports to the second network entity. Further, the controller may be configured to cause the processor 1904 of the device 1902 to perform any of the various operations described herein, such as with reference to a UE 104 and/or the device 1902.

The processor 1904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1904 may be configured to operate a memory array using a memory controller. In some other implementations, a memory controller may be integrated into the processor 1904. The processor 1904 may be configured to execute computer-readable instructions stored in a memory (e.g., the memory 1906) to cause the device 1902 to perform various functions of the present disclosure.

The memory 1906 may include random access memory (RAM) and read-only memory (ROM). The memory 1906 may store computer-readable, computer-executable code including instructions that, when executed by the processor 1904 cause the device 1902 to perform various functions described herein. The code may be stored in a non-transitory computer-readable medium such as system memory or another type of memory. In some implementations, the code may not be directly executable by the processor 1904 but may cause a computer (e.g., when compiled and executed) to perform functions described herein. In some implementations, the memory 1906 may include, among other things, a basic I/O system (BIOS) which may control basic hardware or software operation such as the interaction with peripheral components or devices.

The I/O controller 1910 may manage input and output signals for the device 1902. The I/O controller 1910 may also manage peripherals not integrated into the device 1902. In some implementations, the I/O controller 1910 may represent a physical connection or port to an external peripheral. In some implementations, the I/O controller 1910 may utilize an operating system such as iOS®, ANDROID®, MS-DOS®, MS-WINDOWS®, OS/2®, UNIX®, LINUX®, or another known operating system. In some implementations, the I/O controller 1910 may be implemented as part of a processor, such as the processor 1904. In some implementations, a user may interact with the device 1902 via the I/O controller 1910 or via hardware components controlled by the I/O controller 1910.

In some implementations, the device 1902 may include a single antenna 1912. However, in some other implementations, the device 1902 may have more than one antenna 1912 (e.g., multiple antennas), including multiple antenna panels or antenna arrays, which may be capable of concurrently transmitting or receiving multiple wireless transmissions. The transceiver 1908 may communicate bi-directionally, via the one or more antennas 1912, wired, or wireless links as described herein. For example, the transceiver 1908 may represent a wireless transceiver and may communicate bi-directionally with another wireless transceiver. The transceiver 1908 may also include a modem to modulate the packets, to provide the modulated packets to one or more antennas 1912 for transmission, and to demodulate packets received from the one or more antennas 1912.

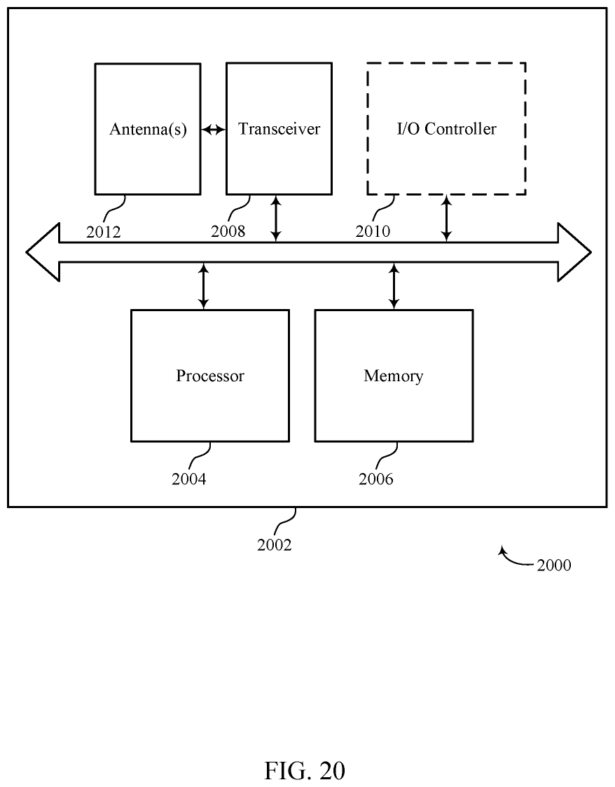

FIG. 20 illustrates an example of a block diagram 2000 of a device 2002 (e.g., an apparatus) that supports device positioning in NTN in accordance with aspects of the present disclosure. The device 2002 may be an example of a network entity 102 as described herein, such as an NTN NG-RAN node. The device 2002 may support wireless communication with one or more network entities 102, UEs 104, or any combination thereof. The device 2002 may include components for bi-directional communications including components for transmitting and receiving communications, such as a processor 2004, a memory 2006, a transceiver 2008, and an I/O controller 2010. These components may be in electronic communication or otherwise coupled (e.g., operatively, communicatively, functionally, electronically, electrically) via one or more interfaces (e.g., buses).

The processor 2004, the memory 2006, the transceiver 2008, or various combinations thereof or various components thereof may be examples of means for performing various aspects of the present disclosure as described herein. For example, the processor 2004, the memory 2006, the transceiver 2008, or various combinations or components thereof may support a method for performing one or more of the operations described herein.

In some implementations, the processor 2004, the memory 2006, the transceiver 2008, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 2004 and the memory 2006 coupled with the processor 2004 may be configured to perform one or more of the functions described herein (e.g., executing, by the processor 2004, instructions stored in the memory 2006). In the context of network entity 102, for example, the transceiver 2008 and the processor 2004 coupled to the transceiver 2008 are configured to cause the network entity 102 to perform the various described operations and/or combinations thereof.

For example, the processor 2004 and/or the transceiver 2008 may support wireless communication at the device 2002 in accordance with examples as disclosed herein. For instance, the processor 2004 and/or the transceiver 2008 may be configured as or otherwise support a means to receive, at a first network entity and from a second network entity, one or more positioning measurement configurations to perform time-based positioning; receive, at the first network entity, one or more uplink positioning reference signals from a target device; perform one or more time-based positioning measurements based at least in part on the one or more uplink positioning reference signals and the one or more positioning measurement configurations; and transmit, based at least in part on the one or more time-based positioning measurements, one or more positioning measurement reports to the second network entity.

Further, in some implementations, the one or more positioning measurement configurations include at least one of satellite link delay information, satellite ephemeris information, or satellite displacement information; the first network entity includes a non-terrestrial network (NTN) next generation radio access network (NG-RAN) node, and the second network entity includes a location server; the NG-RAN node includes one or more of a satellite, a gateway, or a gNB; to perform the one or more time-based positioning measurements, the processor is configured to cause the apparatus to perform a plurality of non-terrestrial network (NTN) gNB receiver-transmitter time difference measurements based at least in part on a feeder link delay and a total delay.

Further, in some implementations, the one or more NTN gNB receiver-transmitter time difference measurements include a difference between a reception time of the one or more uplink positioning reference signals and a transmission time of one or more downlink positioning reference signals; the total delay includes the feeder link delay and a service link delay; the one or more uplink positioning reference signals include one or more of SRS for positioning or MIMO SRS; the processor is configured to cause the apparatus to perform a relative TOA measurement based on a plurality of satellite displacement times and according to the received one or more uplink positioning reference signals; the processor is configured to cause the apparatus to receive, from the second network entity, a non-terrestrial network (NTN) reporting criteria including a set of configurable time instances in which to provide positioning measurement reports; the set of configurable time instances include a number of time instances and absolute reporting times.

The processor 2004 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 2004 may be configured to operate a memory array using a memory controller. In some other implementations, a memory controller may be integrated into the processor 2004. The processor 2004 may be configured to execute computer-readable instructions stored in a memory (e.g., the memory 2006) to cause the device 2002 to perform various functions of the present disclosure.

The memory 2006 may include random access memory (RAM) and read-only memory (ROM). The memory 2006 may store computer-readable, computer-executable code including instructions that, when executed by the processor 2004 cause the device 2002 to perform various functions described herein. The code may be stored in a non-transitory computer-readable medium such as system memory or another type of memory. In some implementations, the code may not be directly executable by the processor 2004 but may cause a computer (e.g., when compiled and executed) to perform functions described herein. In some implementations, the memory 2006 may include, among other things, a basic I/O system (BIOS) which may control basic hardware or software operation such as the interaction with peripheral components or devices.

The I/O controller 2010 may manage input and output signals for the device 2002. The I/O controller 2010 may also manage peripherals not integrated into the device 2002. In some implementations, the I/O controller 2010 may represent a physical connection or port to an external peripheral. In some implementations, the I/O controller 2010 may utilize an operating system such as iOS®, ANDROID®, MS-DOS®, MS-WINDOWS®, OS/2®, UNIX®, LINUX®, or another known operating system. In some implementations, the I/O controller 2010 may be implemented as part of a processor, such as the processor 2004. In some implementations, a user may interact with the device 2002 via the I/O controller 2010 or via hardware components controlled by the I/O controller 2010.

In some implementations, the device 2002 may include a single antenna 2012. However, in some other implementations, the device 2002 may have more than one antenna 2012 (e.g., multiple antennas), including multiple antenna panels or antenna arrays, which may be capable of concurrently transmitting or receiving multiple wireless transmissions. The transceiver 2008 may communicate bi-directionally, via the one or more antennas 2012, wired, or wireless links as described herein. For example, the transceiver 2008 may represent a wireless transceiver and may communicate bi-directionally with another wireless transceiver. The transceiver 2008 may also include a modem to modulate the packets, to provide the modulated packets to one or more antennas 2012 for transmission, and to demodulate packets received from the one or more antennas 2012.

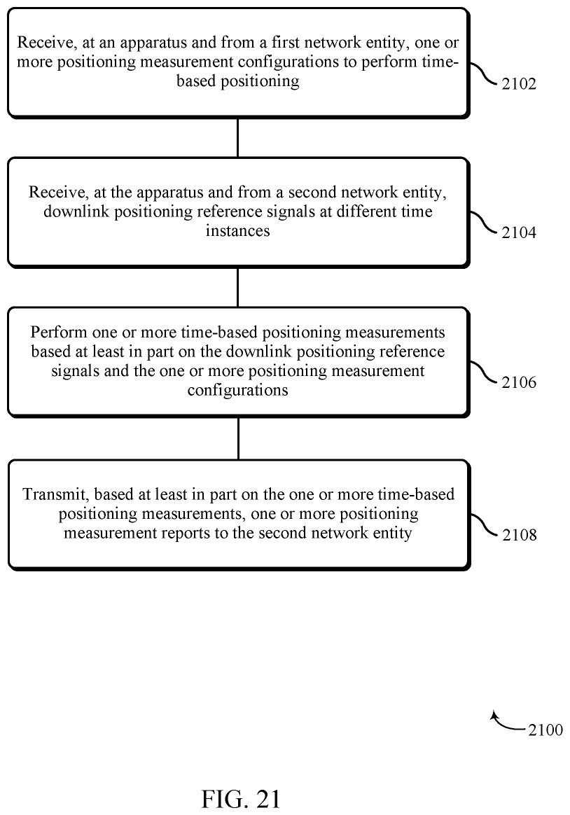

FIG. 21 illustrates a flowchart of a method 2100 that supports device positioning in NTN in accordance with aspects of the present disclosure. The operations of the method 2100 may be implemented by a device or its components as described herein. For example, the operations of the method 2100 may be performed by a UE 104 as described with reference to FIGS. 1 through 20. In some implementations, the device may execute a set of instructions to control the function elements of the device to perform the described functions. Additionally, or alternatively, the device may perform aspects of the described functions using special-purpose hardware.

At 2102, the method may include receiving, at an apparatus and from a first network entity, one or more positioning measurement configurations to perform time-based positioning. The operations of 2102 may be performed in accordance with examples as described herein. In some implementations, aspects of the operations of 2102 may be performed by a device as described with reference to FIG. 1.

At 2104, the method may include receiving, at the apparatus and from a second network entity, downlink positioning reference signals at different time instances. The operations of 2104 may be performed in accordance with examples as described herein. In some implementations, aspects of the operations of 2104 may be performed by a device as described with reference to FIG. 1.

At 2106, the method may include performing one or more time-based positioning measurements based at least in part on the downlink positioning reference signals and the one or more positioning measurement configurations. The operations of 2106 may be performed in accordance with examples as described herein. In some implementations, aspects of the operations of 2106 may be performed by a device as described with reference to FIG. 1.

At 2108, the method may include transmitting, based at least in part on the one or more time-based positioning measurements, one or more positioning measurement reports to the second network entity. The operations of 2108 may be performed in accordance with examples as described herein. In some implementations, aspects of the operations of 2108 may be performed by a device as described with reference to FIG. 1.

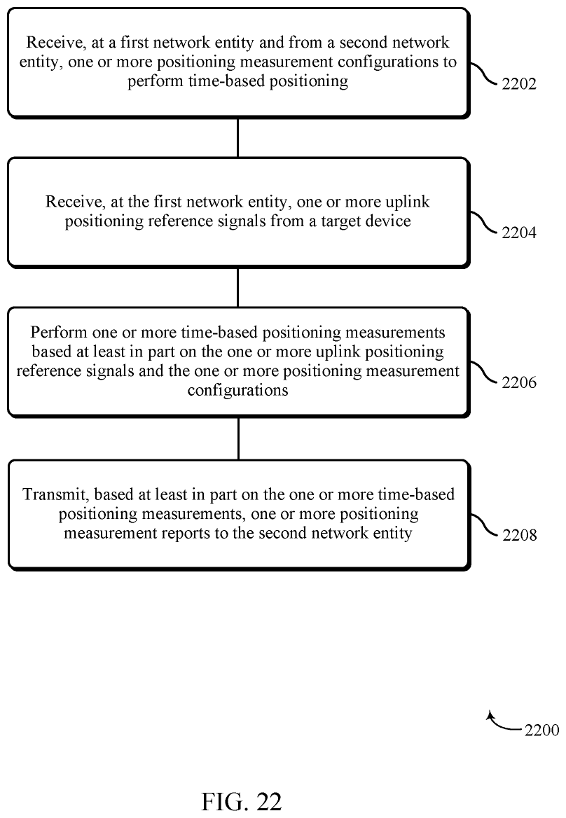

FIG. 22 illustrates a flowchart of a method 2200 that supports device positioning in NTN in accordance with aspects of the present disclosure. The operations of the method 2200 may be implemented by a device or its components as described herein. For example, the operations of the method 2200 may be performed by a network entity 102 as described with reference to FIGS. 1 through 20. In some implementations, the device may execute a set of instructions to control the function elements of the device to perform the described functions. Additionally, or alternatively, the device may perform aspects of the described functions using special-purpose hardware.

At 2202, the method may include receiving, at a first network entity and from a second network entity, one or more positioning measurement configurations to perform time-based positioning. The operations of 2202 may be performed in accordance with examples as described herein. In some implementations, aspects of the operations of 2202 may be performed by a device as described with reference to FIG. 1.

At 2204, the method may include receiving, at the first network entity, one or more uplink positioning reference signals from a target device. The operations of 2204 may be performed in accordance with examples as described herein. In some implementations, aspects of the operations of 2204 may be performed by a device as described with reference to FIG. 1.

At 2206, the method may include performing one or more time-based positioning measurements based at least in part on the one or more uplink positioning reference signals and the one or more positioning measurement configurations. The operations of 2206 may be performed in accordance with examples as described herein. In some implementations, aspects of the operations of 2206 may be performed by a device as described with reference to FIG. 1.

At 2208, the method may include transmitting, based at least in part on the one or more time-based positioning measurements, one or more positioning measurement reports to the second network entity. The operations of 2208 may be performed in accordance with examples as described herein. In some implementations, aspects of the operations of 2208 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity comprising:
at least one memory; and
at least one processor coupled with the at least one memory and operable to cause the first network entity to:
receive one or more positioning measurement configurations to perform time-based positioning;
receive one or more uplink positioning reference signals from a target device;
perform one or more time-based positioning measurements based at least in part on the one or more uplink positioning reference signals and the one or more positioning measurement configurations; and
transmit, based at least in part on the one or more time-based positioning measurements, one or more positioning measurement reports.

2. The first network entity of claim 1, wherein the one or more positioning measurement configurations comprise at least one of satellite link delay information, satellite ephemeris information, or satellite displacement information.

3. The first network entity of claim 1, wherein the first network entity comprises a non-terrestrial network (NTN) next generation radio access network (NG-RAN) node.

4. The first network entity of claim 3, wherein the NG-RAN node comprises one or more of a satellite, a gateway, or a gNB.

5. The first network entity of claim 1, wherein to perform the one or more time-based positioning measurements, the at least one processor is operable to cause the first network entity to perform a plurality of non-terrestrial network (NTN) gNB receiver-transmitter time difference measurements based at least in part on a feeder link delay and a total delay.

6. The first network entity of claim 5, wherein the one or more NTN gNB receiver-transmitter time difference measurements comprise a difference between a reception time of the one or more uplink positioning reference signals and a transmission time of one or more downlink positioning reference signals.

7. The first network entity of claim 5, wherein the total delay comprises the feeder link delay and a service link delay.

8. The first network entity of claim 1, wherein the one or more uplink positioning reference signals comprise one or more of sounding reference signals (SRS) for positioning or multiple input multiple output (MIMO) SRS.

9. The first network entity of claim 1, wherein the at least one processor is operable to cause the first network entity to perform a relative time-of-arrival (TOA) measurement based on a plurality of satellite displacement times and according to the received one or more uplink positioning reference signals.

10. The first network entity of claim 1, wherein the at least one processor is operable to cause the first network entity to receive a non-terrestrial network (NTN) reporting criteria comprising a set of configurable time instances in which to provide positioning measurement reports, wherein the set of configurable time instances comprise a number of time instances and absolute reporting times.

11. (canceled)

12. A user equipment (UE) for wireless communication, comprising:
at least one memory; and
at least one processor coupled with the at least one memory and operable to cause the UE to:
receive one or more positioning measurement configurations to perform time-based positioning;
receive downlink positioning reference signals at different time instances;
perform one or more time-based positioning measurements based at least in part on the downlink positioning reference signals and the one or more positioning measurement configurations; and
transmit, based at least in part on the one or more time-based positioning measurements, one or more positioning measurement reports.

13. The UE of claim 12, wherein:
the one or more positioning measurement configurations are received from a first network entity;
the downlink positioning reference signals at different time instances are received from a second network entity; and
the first network entity comprises a location server, and the second network entity comprises a non-terrestrial network (NTN) next generation radio access network (NG-RAN) node.

14. The UE of claim 12, wherein the one or more positioning measurement configurations comprise at least one of satellite link delay information, satellite ephemeris information, or satellite displacement information.

15. The UE of claim 12, wherein to perform the one or more time-based positioning measurements, the at least one processor is operable to cause the UE to perform non-terrestrial network (NTN) reference signal time difference (RSTD) measurements based at least in part on an observed time difference and a real time difference of satellite displacement times.

16. The UE of claim 15, wherein the at least one processor is operable to cause the UE to perform the NTN RSTD measurements based at least in part on one or more of RSTD measurement uncertainty or RSTD measurement error.

17. The UE of claim 15, wherein the at least one processor is operable to cause the UE to perform the NTN RSTD measurements based at least in part on a relative timing difference between transmission point (TP) at a satellite displacement time t+NT and a reference satellite displacement time t between a pair of transmission slots.

18. The UE of claim 12, wherein the at least one processor is operable to cause the UE to receive a non-terrestrial network (NTN) reporting criteria comprising a set of configurable time instances in which to provide positioning measurement reports.

19. The UE of claim 18, wherein the set of configurable time instances comprise a number of time instances and absolute reporting times.

20. (canceled)

21. A method performed by a user equipment (UE), the method comprising:
receiving one or more positioning measurement configurations to perform time-based positioning;
receiving downlink positioning reference signals at different time instances;
performing one or more time-based positioning measurements based at least in part on the downlink positioning reference signals and the one or more positioning measurement configurations; and
transmitting, based at least in part on the one or more time-based positioning measurements, one or more positioning measurement reports.

22. A method performed by a first network entity, the method comprising:
receiving one or more positioning measurement configurations to perform time-based positioning;
receiving one or more uplink positioning reference signals from a target device;
performing one or more time-based positioning measurements based at least in part on the one or more uplink positioning reference signals and the one or more positioning measurement configurations; and
transmitting, based at least in part on the one or more time-based positioning measurements, one or more positioning measurement reports.
